(19) United States
(12) Patent Application Publication
(10) Pub. No.: US 2024/0349301 A1
(43) Pub. Date: Oct. 17, 2024

(54) TERMINAL APPARATUS, BASE STATION APPARATUS, AND COMMUNICATION METHOD

(71) Applicant: Sharp Kabushiki Kaisha, Sakai City, Osaka (JP)

(72) Inventors: Takahisa FUKUI, Sakai City (JP); Shoichi SUZUKI, Sakai City (JP); Toshizo NOGAMI, Sakai City (JP); Daiichiro NAKASHIMA, Sakai City (JP); Wataru OUCHI, Sakai City (JP); Tomoki YOSHIMURA, Sakai City (JP); Huifa LIN, Sakai City (JP); Ryota MORIMOTO, Sakai City (JP)

(21) Appl. No.: 18/712,845

(22) PCT Filed: Nov. 25, 2022
(86) PCT No.: PCT/JP2022/043481

§ 371 Date: May 23, 2024

(30) Foreign Application Priority Data
Nov. 30, 2021 (JP) 2021-193829

(51) Int. Cl. H04W 72/232; H04W 72/1268

(52) U.S. Cl. CPC H04W 72/232; H04W 72/1268

(57) ABSTRACT

A terminal apparatus includes a receiver that receives a PDCCH to which DCI for scheduling a PUSCH is mapped, a transmitter that transmits the PUSCH, and a higher layer processing unit that manages a first higher layer parameter, a second higher layer parameter, and a third higher layer parameter, in which frequency hopping is applied for the PUSCH based at least on the DCI, the first higher layer parameter is a higher layer parameter for providing whether DMRS bundling for the PUSCH is enabled, the second higher layer parameter is a higher layer parameter for providing a window length of a configured time domain window, in a case that the first higher layer parameter and the third higher layer parameter are provided, a hopping interval for the frequency hopping is determined based on the third higher layer parameter, in a case that the first higher layer parameter and the second higher layer parameter are provided and the third higher layer parameter is not provided, the hopping interval is determined based on the second higher layer parameter, and in a case that the first higher layer parameter is provided and the second higher layer parameter and the third higher layer parameter are not provided, no expectation is performed.

### TECHNICAL FIELD

The present invention relates to a terminal apparatus and a base station apparatus.

This application claims priority to JP 2021-193829 filed on Nov. 30, 2021, the contents of which are incorporated herein by reference.

### BACKGROUND ART

The 3^{rd} Generation Partnership Project (3GPP) has studied a radio access method and a radio network for cellular mobile communications (hereinafter also referred to as “Long Term Evolution (LTE)” or “Evolved Universal Terrestrial Radio Access (EUTRA)”). In LTE, a base station apparatus is also referred to as an evolved NodeB (eNodeB) and a terminal apparatus is also referred to as User Equipment (UE). LTE is a cellular communication system in which multiple areas covered by base station apparatuses are arranged in a form of cells. A single base station apparatus may manage multiple serving cells.

The 3GPP has been studying a next generation standard (New Radio or NR) (NPL 1) to make a proposal for International Mobile Telecommunication (IMT)-2020, a standard for a next generation mobile communication system developed by the International Telecommunication Union (ITU). NR is required to satisfy requirements for three scenarios including enhanced Mobile BroadBand (eMBB), massive Machine Type Communication (mMTC), and Ultra Reliable and Low Latency Communication (URLLC) in a single technology framework.

The 3GPP has studied extension of services supported by NR (NPL 2).

### CITATION LIST

### Non Patent Literature

NPL 1: “New SID proposal: Study on New Radio Access Technology”, RP-160671, NTT docomo, 3GPP TSG RAN Meeting #71, Goteborg, Sweden, Mar. 7 to 10, 2016.
NPL 2: “Release 17 package for RAN”, RP-193216, RAN chairman, RAN1 chairman, RAN2 chairman, RAN3 chairman, 3GPP TSG RAN Meeting #86, Sitges, Spain, Dec. 9 to 12, 2019

### SUMMARY OF INVENTION

### Technical Problem

An aspect of the present invention provides a terminal apparatus that efficiently performs communication, a communication method used for the terminal apparatus, a base station apparatus that efficiently performs communication, and a communication method used for the base station apparatus.

### Solution to Problem

(1) A first aspect of the present invention is a terminal apparatus including a receiver that receives a PDCCH to which DCI for scheduling a PUSCH is mapped, a transmitter that transmits the PUSCH, and a higher layer processing unit that manages a first higher layer parameter, a second higher layer parameter, and a third higher layer parameter, in which frequency hopping is applied for the PUSCH based at least on the DCI, the first higher layer parameter is a higher layer parameter for providing whether DMRS bundling for the PUSCH is enabled, the second higher layer parameter is a higher layer parameter for providing a window length of a configured time domain window, in a case that the first higher layer parameter and the third higher layer parameter are provided, a hopping interval for the frequency hopping is determined based on the third higher layer parameter, in a case that the first higher layer parameter and the second higher layer parameter are provided and the third higher layer parameter is not provided, the hopping interval is determined based on the second higher layer parameter, and in a case that the first higher layer parameter is provided and the second higher layer parameter and the third higher layer parameter are not provided, no expectation is performed.

(2) A second aspect of the present invention is a base station apparatus including a transmitter that transmits a PDCCH to which DCI for scheduling a PUSCH is mapped, a receiver that receives the PUSCH, and a higher layer processing unit that manages a first higher layer parameter, a second higher layer parameter, and a third higher layer parameter, in which frequency hopping is applied for the PUSCH based at least on the DCI, the first higher layer parameter is a higher layer parameter for providing whether DMRS bundling for the PUSCH is enabled, the second higher layer parameter is a higher layer parameter for providing a window length of a configured time domain window, in a case that the first higher layer parameter and the third higher layer parameter are provided, a hopping interval for the frequency hopping is determined based on the third higher layer parameter, in a case that the first higher layer parameter and the second higher layer parameter are provided and the third higher layer parameter is not provided, the hopping interval is determined based on the second higher layer parameter, and in a case that the first higher layer parameter is provided and the second higher layer parameter and the third higher layer parameter are not provided, no expectation is performed.

(3) In addition, a third aspect of the present invention is a communication method used by a terminal apparatus, the communication method including a step of receiving a PDCCH to which DCI for scheduling a PUSCH is mapped, a step of transmitting the PUSCH, and a step of managing a first higher layer parameter, a second higher layer parameter, and a third higher layer parameter, in which frequency hopping is applied for the PUSCH based at least on the DCI, the first higher layer parameter is a higher layer parameter for providing whether DMRS bundling for the PUSCH is enabled, the second higher layer parameter is a higher layer parameter for providing a window length of a configured time domain window, in a case that the first higher layer parameter and the third higher layer parameter are provided, a hopping interval for the frequency hopping is determined based on the third higher layer parameter, in a case that the first higher layer parameter and the second higher layer parameter are provided and the third higher layer parameter is not provided, the hopping interval is determined based on the second higher layer parameter, and in a case that the first higher layer parameter is provided and the second higher layer parameter and the third higher layer parameter are not provided, no expectation is performed.

(4) In addition, a fourth aspect of the present invention is a communication method used by a base station apparatus, the communication method including a step of transmitting a PDCCH to which DCI for scheduling a PUSCH is mapped, a step of receiving the PUSCH, and a step of managing a first higher layer parameter, a second higher layer parameter, and a third higher layer parameter, in which frequency hopping is applied for the PUSCH based at least on the DCI, the first higher layer parameter is a higher layer parameter for providing whether DMRS bundling for the PUSCH is enabled, the second higher layer parameter is a higher layer parameter for providing a window length of a configured time domain window, in a case that the first higher layer parameter and the third higher layer parameter are provided, a hopping interval for the frequency hopping is determined based on the third higher layer parameter, in a case that the first higher layer parameter and the second higher layer parameter are provided and the third higher layer parameter is not provided, the hopping interval is determined based on the second higher layer parameter, and in a case that the first higher layer parameter is provided and the second higher layer parameter and the third higher layer parameter are not provided, no expectation is performed.

### Advantageous Effects of Invention

According to an aspect of the present invention, the terminal apparatus can efficiently perform communication. In addition, the base station apparatus can efficiently perform communication.

### BRIEF DESCRIPTION OF DRAWINGS

FIG. 1 is a conceptual diagram of a radio communication system according to an aspect of the present embodiment.

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment.

FIG. 3 is a diagram illustrating an example of a configuration method of a resource grid according to an aspect of the present embodiment.

FIG. 4 is a diagram illustrating a configuration example of a resource grid 3001 according to an aspect of the present embodiment.

FIG. 5 is a schematic block diagram illustrating a configuration example of a base station apparatus 3 according to an aspect of the present embodiment.

FIG. 6 is a schematic block diagram illustrating a configuration example of a terminal apparatus 1 according to an aspect of the present embodiment.

FIG. 7 is a diagram illustrating a configuration example of an SS/PBCH block according to an aspect of the present embodiment.

FIG. 8 is a diagram illustrating an example of monitoring occasions for search space sets according to an aspect of the present embodiment.

FIG. 9 is a diagram illustrating an example of inter-bundle frequency hopping independent of configured time domain windows according to an aspect of the present embodiment.

FIG. 10 is a diagram illustrating an example of inter-bundle frequency hopping dependent on configured time domain windows according to an aspect of the present embodiment.

### DESCRIPTION OF EMBODIMENTS

An embodiment of the present invention will be described below.
floor(C) may be a floor function for a real number C. For example, floor(C) may be a function that outputs a maximum integer in a range of not exceeding the real number C. ceil(D) may be a ceiling function for a real number D. For example, ceil(D) may be a function that outputs a minimum integer in a range of not falling below the real number D. mod(E, F) may be a function that outputs a remainder obtained by dividing E by F. mod(E, F) may be a function that outputs a value corresponding to the remainder obtained by dividing E by F. exp(G)=e\hat{ }G. Here, e is Napier's constant. H\hat{ }I represents H to the power of I. max(J, K) is a function that outputs the maximum value of J and K. Here, in a case that J and K are equal, max(J, K) is a function that outputs J or K. min(L, M) is a function that outputs the maximum value of L and M. Here, in a case that L and M are equal, min(L, M) is a function that outputs L or M. round(N) is a function that outputs an integer value of a value closest to N. “·” represents multiplication.

In a radio communication system according to an aspect of the present embodiment, at least Orthogonal Frequency Division Multiplexing (OFDM) is used. An OFDM symbol is a unit of the time domain in OFDM. An OFDM symbol includes at least one or multiple subcarriers. An OFDM symbol is converted into a time-continuous signal in generation of a baseband signal. In downlink, at least Cyclic Prefix-Orthogonal Frequency Division Multiplexing (CP-OFDM) is used. In uplink, either CP-OFDM or Discrete Fourier Transform-Spread-Orthogonal Frequency Division Multiplexing (DFT-s-OFDM) is used. DFT-s-OFDM may be given by applying transform precoding to CP-OFDM.

An OFDM symbol may be a term including a CP added to an OFDM symbol. That is, a certain OFDM symbol may include the certain OFDM symbol and a CP added to the certain OFDM symbol.

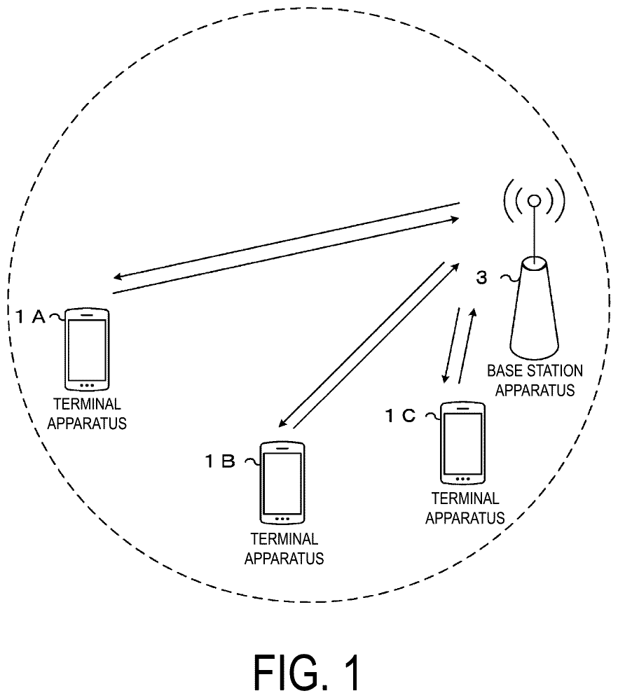

FIG. 1 is a conceptual diagram of a radio communication system according to an aspect of the present embodiment. In FIG. 1, the radio communication system includes at least terminal apparatuses 1A to 1C and a base station apparatus 3 (Base Station #3 (BS #3)). Hereinafter, the terminal apparatuses 1A to 1C are also referred to as terminal apparatuses 1 (User Equipment #1 (UE #1)).

The base station apparatus 3 may include one or multiple transmission apparatuses (or transmission points, transmission and/or reception apparatuses, transmission and/or reception points). In a case that the base station apparatus 3 includes multiple transmission apparatuses, the multiple transmission apparatuses may be arranged at different positions.

The base station apparatus 3 may provide one or multiple serving cells. Each serving cell may be defined as a set of resources used for radio communication. In addition, a serving cell is also referred to as a cell.

A serving cell may include either or both of one downlink component carrier (downlink carrier) and one uplink component carrier (uplink carrier). The serving cell may include either or both of two or more downlink component carriers, and/or two or more uplink component carriers. A downlink component carrier and an uplink component carrier are also collectively referred to as component carriers (carriers).

For example, for each component carrier, one resource grid may be given. In addition, one resource grid may be given to each set of one component carrier and a certain subcarrier spacing configuration μ. Here, the subcarrier spacing configuration p is also referred to as numerology. For example, one resource grid may be given to a set of a certain antenna port p, a certain subcarrier spacing configuration μ, and a certain transmission direction x.

The resource grid includes N^{size,μ}_{grid,x}N^{RB}_{sc} subcarriers. Here, the resource grid starts from a common resource block N^{start,μ}_{grid,x}. The common resource block N^{start,μ}_{grid,x} is also referred to as a reference point of the resource grid.

The resource grid includes N^{subframe,μ}_{symb} OFDM symbols.

The subscript x added to the parameter associated with the resource grid indicates the transmission direction. For example, the subscript x may be used to indicate either of downlink or uplink.

N^{size,μ}_{grid,x} is an offset configuration indicated by a parameter provided by the RRC layer (e.g., parameter CarrierBandwidth). N^{start,μ}_{grid,x} is a band configuration indicated by a parameter provided by the RRC layer (e.g., parameter, OffsetToCarrier). The offset configuration and the band configuration are configurations used for configuring an SCS-specific carrier.

The SubCarrier Spacing (SCS) Δf for a certain subcarrier spacing configuration μ may be Δf=2^{μ}*15 kHz. Here, the subcarrier spacing configuration μ may indicate one of 0, 1, 2, 3, or 4.

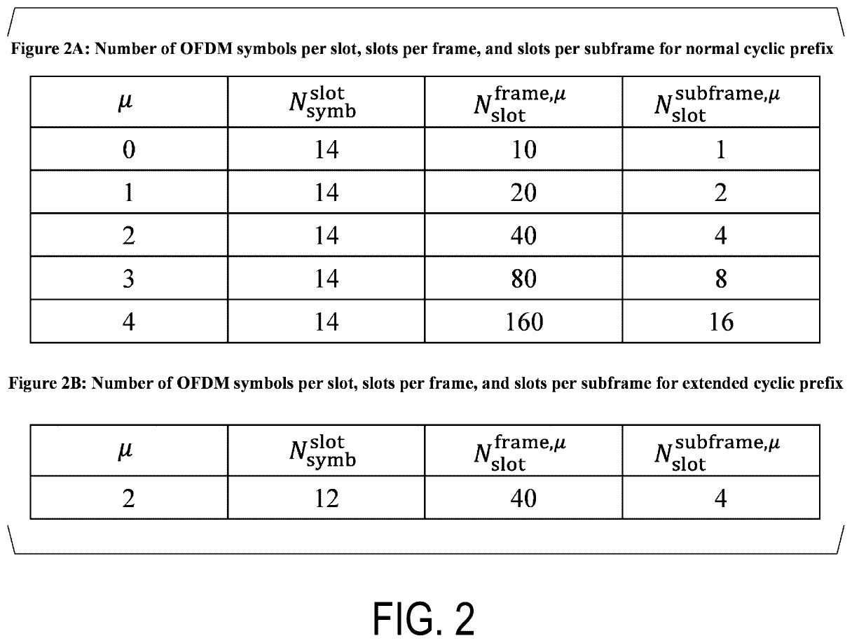

FIG. 2 is an example illustrating a relationship between the subcarrier spacing configuration μ, the number of OFDM symbols per slot N^{slot}_{symb}, and a cyclic Prefix (CP) configuration according to an aspect of the present embodiment. In FIG. 2A, for example, in a case that the subcarrier spacing configuration μ is 2 and the CP configuration is a normal cyclic prefix (normal CP), N^{slot}_{symb}=14, N^{frame,μ}ₛₗₒₜ=40, and N^{subfram,μ}ₛₗₒₜ=4. In addition, in FIG. 2B, for example, in a case that the subcarrier spacing configuration μ is 2 and the CP configuration is an extended cyclic prefix (extended CP), N^{slot}_{symb}=12, N^{subframe,μ}ₛₗₒₜ=40, and N^{subframe,μ}ₛₗₒₜ=4.

The time unit T_{c} may be used to represent the length of the time domain. The time unit T_{c} is T_{c}=1/(Δfₘₐₓ·N_{f}). Δfₘₐₓ=480 kHz. N_{f}=4096. A constant κ is κ=Δfₘₐₓ·N_{f}/(Δf_{ref}N_{f,ref})=64. Δf_{ref} is 15 kHz. N_{f,ref} is 2048.

Transmission of a signal in downlink and/or transmission of a signal in uplink may be organized into a radio frame (system frame, frame) having a length T_{f}. T_{f}=(ΔfₘₐₓN_{f}/100)·Tₛ=10 ms. The radio frame includes 10 subframes. The length T_{sf} of the subframe is (ΔfₘₐₓN_{f}/1000)·Tₛ=1 ms. The number of OFDM symbols per subframe is N^{subframep}_{symb}=N^{slot}_{symb}N^{subframe,μ}ₛₗₒₜ.

The OFDM symbol is a time domain unit of one communication scheme. For example, the OFDM symbol may be a time domain unit of CP-OFDM. In addition, the OFDM symbol may be a time domain unit of DFT-s-OFDM.

A slot may include multiple OFDM symbols. For example, N^{slot}_{symb} consecutive OFDM symbols may constitute one slot. For example, in normal CP configuration, N^{slot}_{symb}=14 may be satisfied. In extended CP configuration, N^{slot}_{symb}=12 may be satisfied.

For a certain subcarrier spacing configuration μ, the number of slots and indices included in the subframe may be given. For example, a slot index n^{μ}ₛ may be given in ascending order of integer values in a range of 0 to N^{subframe,μ}ₛₗₒₜ−1 in a subframe. For the subcarrier spacing configuration μ, the number of slots and indices included in a radio frame may be given. In addition, a slot index n^{μ}_{s,f} may be given in ascending order of integer values in a range of 0 to N^{frame,μ}ₛₗₒₜ−1 in a radio frame.

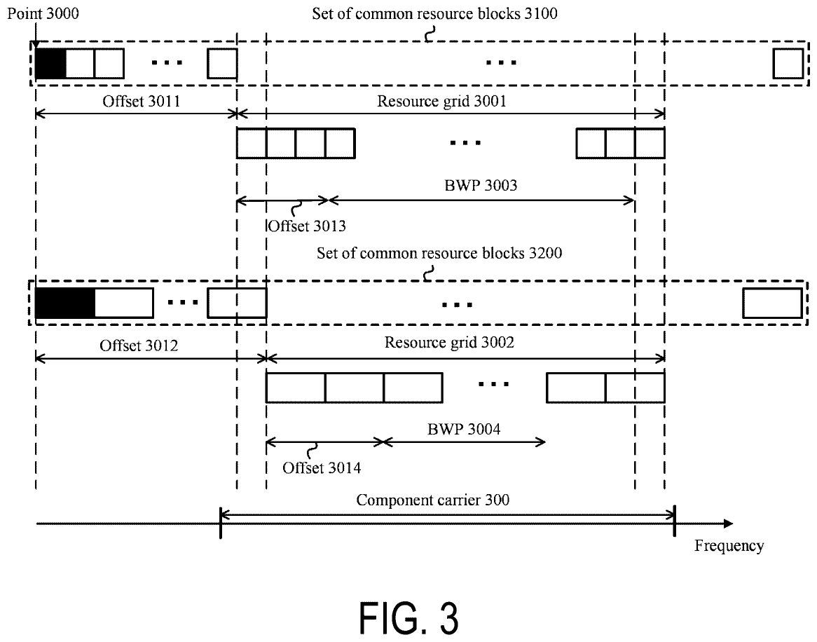

FIG. 3 is a diagram illustrating an example of a configuration method of a resource grid according to an aspect of the present embodiment. The horizontal axis of FIG. 3 represents a frequency domain. FIG. 3 illustrates a configuration example of a resource grid of a subcarrier spacing μ₁ in a component carrier 300, and a configuration example of a resource grid of a subcarrier spacing μ₂ in the certain component carrier. As described above, for a certain component carrier, one or multiple subcarrier spacings may be configured. In FIG. 3, although μ₁=μ₂−1 is assumed, various aspects of the present embodiment are not limited to the condition of μ₁=μ₂−1.

The component carrier 300 is a band having a predetermined width in the frequency domain.

A point 3000 is an identifier for identifying a certain subcarrier. The point 3000 is also referred to as a point A. A set of Common Resource Blocks (CRBs) set 3100 is a set of common resource blocks for a subcarrier spacing configuration μ₁.

In the common resource block set 3100, a common resource block (solid black block in the common resource block set 3100 in FIG. 3) including the point 3000 is also referred to as a reference point of the common resource block set 3100. The reference point of the common resource block set 3100 may be a common resource block having an index 0 in the common resource block set 3100.

An offset 3011 is an offset from the reference point of the common resource block set 3100 to a reference point of a resource grid 3001. The offset 3011 is represented by the number of common resource blocks for the subcarrier spacing configuration μ₁. The resource grid 3001 includes N^{size,μ}_{grid1,x} common resource blocks starting from the reference point of the resource grid 3001.

An offset 3013 is an offset from the reference point of the resource grid 3001 to a reference point (N^{start,μ}_{BWP,i1}) of a BandWidth Part (BWP) 3003 having an index i1.

A common resource block set 3200 is a set of common resource blocks for a subcarrier spacing configuration μ₂.

In the common resource block set 3200, a common resource block (solid black block in the common resource block set 3200 in FIG. 3) including the point 3000 is also referred to as a reference point of the common resource block set 3200. The reference point of the common resource block set 3200 may be a common resource block having an index 0 in the common resource block set 3200.

An offset 3012 is an offset from the reference point of the common resource block set 3200 to a reference point of a resource grid 3002. The offset 3012 is represented by the number of common resource blocks for the subcarrier spacing μ₂. The resource grid 3002 includes N^{size,μ}_{grid2,x} common resource blocks starting from the reference point of the resource grid 3002.

An offset 3014 is an offset from the reference point of the resource grid 3002 to a reference point (N^{start,μ}_{BWP,i2}) of a BWP 3004 having an index i2.

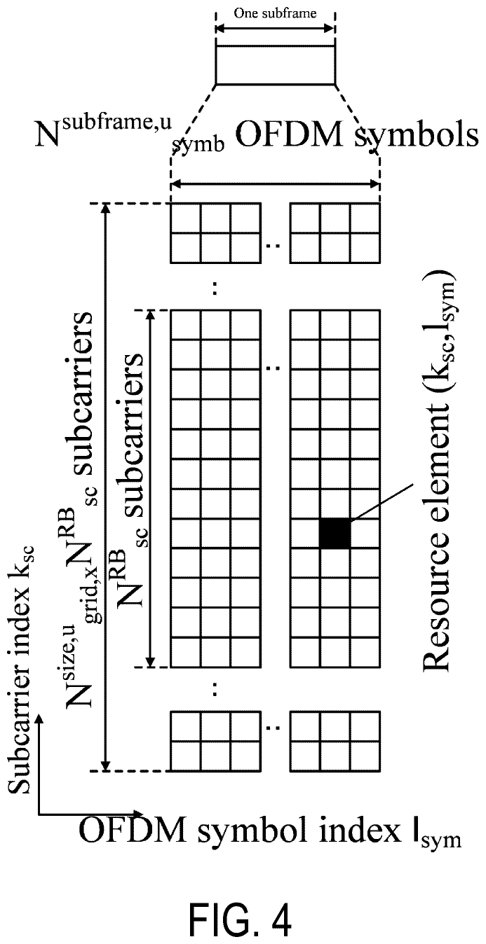

FIG. 4 is a diagram illustrating a configuration example of the resource grid 3001 according to an aspect of the present embodiment. In the resource grid of FIG. 4, the horizontal axis corresponds to an OFDM symbol index l_{sym}, and the vertical axis corresponds to a subcarrier index k_{sc}. The resource grid 3001 includes N^{size,μ}_{grid1,x}N^{RB}_{sc} subcarriers, and N^{subframe,μ}_{symb} OFDM symbols. In the resource grid, a resource identified by the subcarrier index k_{sc} and the OFDM symbol index l_{sym} is also referred to as a Resource Element (RE).

A Resource Block (RB) includes N^{RB}_{sc} consecutive subcarriers. The resource block is a general term for a common resource block, a Physical Resource Block (PRB), and a Virtual Resource Block (VRB). Here, N^{RB}_{sc}=12.

A resource block unit is a set of resources corresponding to one OFDM symbol in one resource block. That is, one resource block unit includes 12 resource elements corresponding to one OFDM symbol in one resource block.

The common resource blocks for a certain subcarrier spacing configuration μ are given indices in ascending order from 0 in the frequency domain in a certain common resource block set (indexing). The common resource block having the index 0 for a certain subcarrier spacing configuration μ includes (or collides with or matches) the point 3000. An index n^{μ}_{CRB} of the common resource block for a certain subcarrier spacing configuration μ satisfies a relationship n^{μ}_{CRB}=ceil(k_{sc}/N^{RB}_{sc}). Here, a subcarrier with k_{sc}=0 is a subcarrier having the same center frequency as the center frequency of a subcarrier corresponding to the point 3000.

Physical resource blocks for a certain subcarrier spacing configuration μ are given indices in ascending order from 0 in the frequency domain in a certain BWP. An index n^{μ}_{PRB} of the physical resource block for a certain subcarrier spacing configuration μ satisfies a relationship n^{μ}_{CRB}=n^{μ}_{PRB}+N^{start,μ}_{BWP,i}. Here, N^{start,μ}_{BWP,i} indicates a reference point of the BWP having an index i.

The BWP is defined as a subset of common resource blocks included in a resource grid. The BWP includes N^{size,μ}_{BWP,i} common resource blocks starting from the reference point N^{start,μ}_{BWP,i} of the BWP. A BWP configured for a downlink carrier is also referred to as a downlink BWP. A BWP configured for an uplink component carrier is also referred to as an uplink BWP.

An antenna port is defined such that the channel over which a symbol on the antenna port is conveyed can be inferred from the channel over which another symbol on the same antenna port is conveyed. For example, the channel may correspond to a physical channel. In addition, the symbol may correspond to an OFDM symbol. In addition, the symbol may also correspond to a resource block unit. In addition, the symbol may correspond to a resource element.

The fact that a large scale property of a channel over which a symbol on one antenna port is conveyed can be inferred from a channel over which a symbol on another antenna port is conveyed is referred to as the two antenna ports being Quasi Co-Located (QCL). Here, the large scale property may include at least a long term performance of a channel. The large scale property may include at least some or all of delay spread, Doppler spread, Doppler shift, an average gain, an average delay, and a beam parameter (spatial Rx parameters). The fact that the first antenna port and the second antenna port are QCL with respect to a beam parameter may mean that a reception beam assumed by a receiver side for the first antenna port and a reception beam assumed by the receiver side for the second antenna port are the same (or the reception beams correspond to each other). The fact that the first antenna port and the second antenna port are QCL with respect to a beam parameter may mean that a transmission beam assumed by the receiver side for the first antenna port and a transmission beam assumed by the receiver side for the second antenna port are the same (or the transmission beams correspond to each other). In a case that the large scale property of a channel over which a symbol on one antenna port is conveyed can be inferred from a channel over which a symbol on another antenna port is conveyed, the terminal apparatus 1 may assume that the two antenna ports are QCL. The fact that two antenna ports are QCL may mean that the two antenna ports are assumed to be QCL.

Carrier aggregation may mean that communication is performed by using multiple serving cells being aggregated. In addition, carrier aggregation may mean that communication is performed by using multiple component carriers being aggregated. Carrier aggregation may mean that communication is performed by using multiple downlink component carriers being aggregated. Carrier aggregation may mean that communication is performed by using multiple uplink component carriers being aggregated.

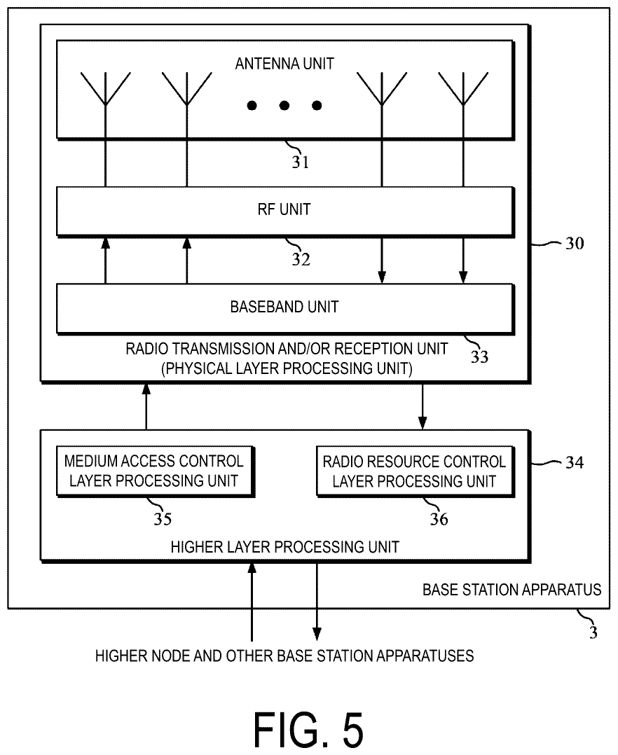

FIG. 5 is a schematic block diagram illustrating a configuration example of the base station apparatus 3 according to an aspect of the present embodiment. As illustrated in FIG. 5, the base station apparatus 3 includes at least a part or all of a radio transmission and/or reception unit (physical layer processing unit) 30 and/or a Higher Layer processing unit 34. The radio transmission and/or reception unit 30 includes at least a part or all of an antenna unit 31, a Radio Frequency (RF) part 32, and a baseband unit 33. The higher layer processing unit 34 includes at least a part or all of a medium access control layer processing unit 35 and a Radio Resource Control (RRC) layer processing unit 36.

The radio transmission and/or reception unit 30 includes at least a part or all of a radio transmitter 30a and a radio receiver 30b. Here, apparatus configurations of the baseband unit included in the radio transmitter 30a and the baseband unit included in the radio receiver 30b may be the same as or different from each other. In addition, apparatus configurations of the RF unit included in the radio transmitter 30a and the RF unit included in the radio receiver 30b may be the same as or different from each other. In addition, apparatus configurations of the antenna unit included in the radio transmitter 30a and the antenna unit included in the radio receiver 30b may be the same as or different from each other.

For example, the radio transmitter 30a may generate and transmit a baseband signal of a PDSCH. For example, the radio transmitter 30a may generate and transmit a baseband signal of a PDCCH. For example, the radio transmitter 30a may generate and transmit a baseband signal of a PBCH. For example, the radio transmitter 30a may generate and transmit a baseband signal of a synchronization signal. For example, the radio transmitter 30a may generate and transmit a baseband signal of a PDSCH DMRS. For example, the radio transmitter 30a may generate and transmit a baseband signal of a PDCCH DMRS. For example, the radio transmitter 30a may generate and transmit a baseband signal of a CSI-RS. For example, the radio transmitter 30a may generate and transmit a baseband signal of a DL PTRS.

For example, the radio receiver 30b may receive a PRACH. For example, the radio receiver 30b may receive and demodulate a PUCCH. The radio receiver 30b may receive and demodulate a PUSCH. For example, the radio receiver 30b may receive a PUCCH DMRS. For example, the radio receiver 30b may receive a PUSCH DMRS. For example, the radio receiver 30b may receive a UL PTRS. For example, the radio receiver 30b may receive an SRS.

The higher layer processing unit 34 outputs downlink data (a transport block) to the radio transmission and/or reception unit 30 (or the radio transmitter 30a). The higher layer processing unit 34 performs processing operations of a Medium Access Control (MAC) layer, a Packet Data Convergence Protocol (PDCP) layer, a Radio Link Control (RLC) layer, and an RRC layer.

The medium access control layer processing unit 35 included in the higher layer processing unit 34 performs processing of the MAC layer.

The radio resource control layer processing unit 36 included in the higher layer processing unit 34 performs processing of the RRC layer. The radio resource control layer processing unit 36 manages various pieces of configuration information/parameters (RRC parameters) of the terminal apparatus 1. The radio resource control layer processing unit 36 sets a parameter based on an RRC message received from the terminal apparatus 1.

The radio transmission and/or reception unit 30 (or the radio transmitter 30a) performs processing such as modulation and encoding. The radio transmission and/or reception unit 30 (or the radio transmitter 30a) generates a physical signal through modulation, encoding, and baseband signal generation (conversion into a time-continuous signal) on the downlink data, and transmits the physical signal to the terminal apparatus 1. The radio transmission and/or reception unit 30 (or the radio transmitter 30a) may map the physical signal to a certain component carrier and transmit the physical signal to the terminal apparatus 1.

The radio transmission and/or reception unit 30 (or the radio receiver 30b) performs processing such as demodulation and decoding. The radio transmission and/or reception unit 30 (or the radio receiver 30b) separates, demodulates, and decodes the received physical signal, and outputs the decoded information to the higher layer processing unit 34. The radio transmission and/or reception unit 30 (or the radio receiver 30b) may perform a channel access procedure prior to transmission of the physical signal.

The RF unit 32 converts (down-converts) a signal received via the antenna unit 31 into a baseband signal by means of orthogonal demodulation and removes unnecessary frequency components. The RF unit 32 outputs a processed analog signal to the baseband unit.

The baseband unit 33 converts the analog signal input from the RF unit 32 into a digital signal. The baseband unit 33 removes a portion corresponding to a Cyclic Prefix (CP) from the converted digital signal, performs a Fast Fourier Transform (FFT) on the signal from which the CP has been removed, and extracts a signal of the frequency domain.

The baseband unit 33 performs Inverse Fast Fourier Transform (IFFT) on the data to generate an OFDM symbol, adds a CP to the generated OFDM symbol, generates a baseband digital signal, and converts the baseband digital signal into an analog signal. The baseband unit 33 outputs the converted analog signal to the RF unit 32.

The RF unit 32 removes an unnecessary frequency component from the analog signal input from the baseband unit 33 by using a low-pass filter, up-converts the analog signal into a signal having a carrier frequency, and transmits the signal via the antenna unit 31. In addition, the RF unit 32 may have a function of controlling transmission power. The RF unit 32 is also referred to as a transmission power controller.

For the terminal apparatus 1, one or multiple serving cells (or component carriers, downlink component carriers, uplink component carriers) may be configured.

Each of the serving cells configured for the terminal apparatus 1 may be one of a Primary Cell (PCell), a Primary SCG Cell (PSCell), or a Secondary Cell (SCell).

The PCell is a serving cell included in a Master Cell Group (MCG). The PCell is a cell in which an initial connection establishment procedure or a connection re-establishment procedure is performed (has been performed) by the terminal apparatus 1.

The PSCell is a serving cell included in a Secondary Cell Group (SCG). The PSCell is a serving cell in which random access is performed by the terminal apparatus 1.

The SCell may be included in either of the MCG or the SCG.

A serving cell group (cell group) is a term at least including an MCG and an SCG. The serving cell group may include one or multiple serving cells (or component carriers). One or multiple serving cells (or component carriers) included in the serving cell group may be operated by means of carrier aggregation.

One or multiple downlink BWPs may be configured for each of the serving cells (or downlink component carriers). One or multiple uplink BWPs may be configured for each of the serving cells (or uplink component carriers).

Among one or multiple downlink BWPs configured for the serving cell (or the downlink component carrier), one downlink BWP may be configured as an active downlink BWP (or one downlink BWP may be activated). Among one or multiple uplink BWPs configured for the serving cell (or the uplink component carrier), one uplink BWP may be configured as an active uplink BWP (or one uplink BWP may be activated).

The PDSCH, the PDCCH, and the CSI-RS may be received in the active downlink BWP. The terminal apparatus 1 may attempt to receive the PDSCH, the PDCCH, and the CSI-RS in the active downlink BWP. The PUCCH and the PUSCH may be transmitted in the active uplink BWP. The terminal apparatus 1 may transmit the PUCCH and the PUSCH in the active uplink BWP. An active downlink BWP and an active uplink BWP are also collectively referred to as active BWPs.

The PDSCH, the PDCCH, and the CSI-RS need not be received in downlink BWPs (inactive downlink BWPs) other than an active downlink BWP. The terminal apparatus 1 need not attempt to receive the PDSCH, the PDCCH, and the CSI-RS in downlink BWPs that are not active downlink BWPs. The PUCCH and the PUSCH need not be transmitted in uplink BWPs (inactive uplink BWPs) that are not active uplink BWPs. The terminal apparatus 1 need not transmit the PUCCH and the PUSCH in uplink BWPs that are not active uplink BWPs. The inactive downlink BWP and the inactive uplink BWP are also collectively referred to as inactive BWPs.

Downlink BWP switch is a procedure for deactivating one active downlink BWP of a certain serving cell and activating any one of inactive downlink BWPs of the certain serving cell. The downlink BWP switch may be controlled by a BWP field included in downlink control information. The downlink BWP switch may be controlled based on a parameter of a higher layer.

Uplink BWP switch is used for deactivating one active uplink BWP and activating any one of inactive uplink BWPs that are not the one active uplink BWP. The uplink BWP switch may be controlled by a BWP field included in downlink control information. The uplink BWP switch may be controlled based on a parameter of a higher layer.

Among one or multiple downlink BWPs configured for a serving cell, two or more downlink BWPs need not be configured for an active downlink BWP. For the serving cell, at certain times, one downlink BWP may be active.

Among one or multiple uplink BWPs configured for a serving cell, two or more uplink BWPs need not be configured for an active uplink BWP. For the serving cell, at certain times, one uplink BWP may be active.

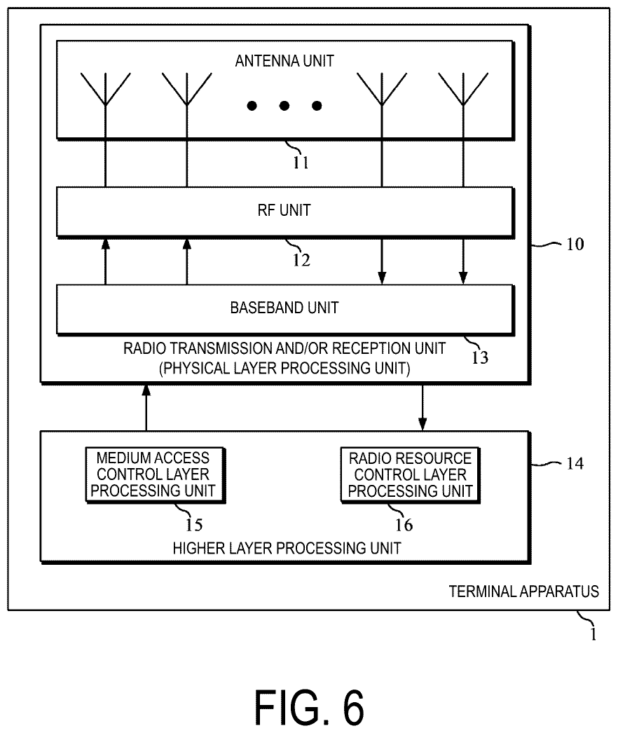

FIG. 6 is a schematic block diagram illustrating a configuration example of the terminal apparatus 1 according to an aspect of the present embodiment. As illustrated in FIG. 6, the terminal apparatus 1 includes at least one or all of a radio transmission and/or reception unit (physical layer processing unit) 10 and a higher layer processing unit 14. The radio transmission and/or reception unit 10 includes at least some or all of an antenna unit 11, an RF unit 12, and a baseband unit 13. The higher layer processing unit 14 includes at least some or all of a medium access control layer processing unit 15 and a radio resource control layer processing unit 16.

The radio transmission and/or reception unit 10 includes at least some or all of a radio transmitter 10a and a radio receiver 10b. Here, apparatus configurations of the baseband unit 13 included in the radio transmitter 10a and the baseband unit 13 included in the radio receiver 10b may be the same as or different from each other. In addition, apparatus configurations of the RF unit 12 included in the radio transmitter 10a and the RF unit 12 included in the radio receiver 10b may be the same as or different from each other. In addition, apparatus configurations of the antenna unit 11 included in the radio transmitter 10a and the antenna unit 11 included in the radio receiver 10b may be the same as or different from each other.

For example, the radio transmitter 10a may generate and transmit a baseband signal of the PRACH. For example, the radio transmitter 10a may generate and transmit a baseband signal of the PUCCH. The radio transmitter 10a may generate and transmit a baseband signal of the PUSCH. For example, the radio transmitter 10a may generate and transmit a baseband signal of the PUCCH DMRS. For example, the radio transmitter 10a may generate and transmit a baseband signal of the PUSCH DMRS. For example, the radio transmitter 10a may generate and transmit a baseband signal of the UL PTRS. For example, the radio transmitter 10a may generate and transmit a baseband signal of the SRS.

For example, the radio receiver 10b may receive and demodulate the PDSCH. For example, the radio receiver 10b may receive and demodulate the PDCCH. For example, the radio receiver 10b may receive and demodulate the PBCH. For example, the radio receiver 10b may receive a synchronization signal. For example, the radio receiver 10b may receive the PDSCH DMRS. For example, the radio receiver 10b may receive the PDCCH DMRS. For example, the radio receiver 10b may receive the CSI-RS. For example, the radio receiver 10b may receive the DL PTRS.

The higher layer processing unit 14 outputs uplink data (a transport block) to the radio transmission and/or reception unit 10 (or the radio transmitter 10a). The higher layer processing unit 14 performs processing operations of the MAC layer, a packet data convergence protocol layer, a radio link control layer, and the RRC layer.

The medium access control layer processing unit 15 included in the higher layer processing unit 14 performs processing of the MAC layer.

The radio resource control layer processing unit 16 included in the higher layer processing unit 14 performs processing of the RRC layer. The radio resource control layer processing unit 16 manages various types of configuration information/parameters (RRC parameters) of the terminal apparatus 1. The radio resource control layer processing unit 16 sets the RRC parameters based on an RRC message received from the base station apparatus 3.

The radio transmission and/or reception unit 10 (or the radio transmitter 10a) performs processing such as modulation and encoding. The radio transmission and/or reception unit 10 (or the radio transmitter 10a) generates a physical signal through modulation, encoding, and baseband signal generation (conversion into a time-continuous signal) of uplink data and transmits the physical signal to the base station apparatus 3. The radio transmission and/or reception unit 10 (or the radio transmitter 10a) may map the physical signal to a certain BWP (an active uplink BWP) and transmit the physical signal to the base station apparatus 3.

The radio transmission and/or reception unit 10 (or the radio receiver 10b) performs processing such as demodulation and decoding. The radio transmission and/or reception unit 10 (or the radio receiver 30b) may receive the physical signal in a certain BWP (active downlink BWP) of a certain serving cell. The radio transmission and/or reception unit 10 (or the radio receiver 10b) separates, demodulates, and decodes the received physical signal and outputs the decoded information to the higher layer processing unit 14. The radio transmission and/or reception unit 10 (radio receiver 10b) may perform a channel access procedure prior to the transmission of the physical signal.

The RF unit 12 converts (down-converts) a signal received via the antenna unit 11 into a baseband signal by means of orthogonal demodulation and removes unnecessary frequency components. The RF unit 12 outputs a processed analog signal to the baseband unit 13.

The baseband unit 13 converts the analog signal input from the RF unit 12 into a digital signal. The baseband unit 13 removes a portion corresponding to a Cyclic Prefix (CP) from the converted digital signal, performs a Fast Fourier Transform (FFT) on the signal from which the CP has been removed, and extracts the signal of the frequency domain.

The baseband unit 13 performs an Inverse Fast Fourier Transform (IFFT) on the uplink data to generate an OFDM symbol, adds a CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 through a low-pass filter, up-converts the analog signal into a signal having a carrier frequency, and transmits the signal via the antenna unit 11. In addition, the RF unit 12 may have a function of controlling transmission power. The RF unit 12 is also referred to as a transmission power controller.

The physical signal (signal) will be described below.

The physical signal is a general term for a downlink physical channel, a downlink physical signal, an uplink physical channel, and an uplink physical channel. The physical channel is a general term for a downlink physical channel and an uplink physical channel. The physical signal is a general term for a downlink physical signal and an uplink physical signal.

The uplink physical channel may correspond to a set of resource elements for conveying information that is generated in a Higher layer. The uplink physical channel may be a physical channel used in an uplink component carrier. The uplink physical channel may be transmitted by the terminal apparatus 1. The uplink physical channel may be received by the base station apparatus 3. In the radio communication system according to an aspect of the present embodiment, at least some or all of the following uplink physical channels may be used.
Physical Uplink Control CHannel (PUCCH)
Physical Uplink Shared CHannel (PUSCH)
Physical Random Access CHannel (PRACH)

The PUCCH may be used to transmit Uplink Control Information (UCI). The PUCCH may be transmitted for conveying (delivering or transmitting) uplink control information. The uplink control information may be mapped to the PUCCH. The terminal apparatus 1 may transmit the PUCCH to which the uplink control information is mapped. The base station apparatus 3 may receive the PUCCH to which the uplink control information is mapped.

The uplink control information (uplink control information bit, uplink control information sequence, or uplink control information type) includes at least some or all of Channel State Information (CSI), a Scheduling Request (SR), and Hybrid Automatic Repeat request ACKnowledgement (HARQ-ACK) information.

The channel state information is also referred to as a channel state information bit or a channel state information sequence. The scheduling request is also referred to as a scheduling request bit or a scheduling request sequence. The HARQ-ACK information is also referred to as a HARQ-ACK information bit or a HARQ-ACK information sequence.

The HARQ-ACK information may include at least a HARQ-ACK corresponding to a Transport Block (TB). The HARQ-ACK may indicate an acknowledgement (ACK) or a negative-acknowledgement (NACK) corresponding to a transport block. An ACK may indicate that a transport block has been successfully decoded. A NACK may indicate that a transport block has not been successfully decoded. The HARQ-ACK information may include a HARQ-ACK codebook including one or multiple HARQ-ACK bits.

A transport block is a sequence of information bits delivered from a higher layer. Here, a sequence of information bits is also referred to as a bit sequence. Here, the transport block may be delivered through an UpLink-Shared CHannel (UL-SCH) of a Transport layer.

A HARQ-ACK for a transport block may be referred to as a HARQ-ACK for the PDSCH. In this case, the “HARQ-ACK for the PDSCH” indicates a HARQ-ACK for the transport block included in the PDSCH.

A HARQ-ACK may indicate an ACK or a NACK corresponding to one Code Block Group (CBG) included in a transport block.

The scheduling request may be at least used for requesting a resource of the UL-SCH for new transmission. The scheduling request bit may be used for indicating either of a positive SR or a negative SR. A scheduling request bit indicating the positive SR is also referred to as a “positive SR being conveyed”. A positive SR may indicate that the terminal apparatus 1 requests resources of the UL-SCH for new transmission. The positive SR may indicate that a scheduling request is triggered by a higher layer. The positive SR may be conveyed in a case that the higher layer indicates a scheduling request. A scheduling request bit indicating the negative SR is also referred to as a “negative SR being transmitted”. The negative SR may indicate that the terminal apparatus 1 requests no resources of the UL-SCH for new transmission. The negative SR may indicate that no scheduling request is triggered by a higher layer. The negative SR may be conveyed in a case that the higher layer indicates no scheduling request.

Channel state information may include at least some or all of a Channel Quality Indicator (CQI), a Precoder Matrix Indicator (PMI), and a Rank Indicator (RI). A CQI is an indicator related to the quality of a propagation path (for example, propagation strength) or the quality of a physical channel, and the PMI is an indicator related to a precoder. An RI is an indicator related to a transmission rank (or the number of transmission layers).

The channel state information is an indicator related to a reception state of a physical signal (for example, CSI-RS) at least used for channel measurement. A value of channel state information may be determined by the terminal apparatus 1 based on the reception state assumed by the physical signal at least used for channel measurement. Channel measurement may include interference measurement.

The PUCCH may correspond to a PUCCH format. The PUCCH may be a set of resource elements used for conveying the PUCCH format. The PUCCH may include the PUCCH format. The PUCCH may be transmitted with a certain PUCCH format. Further, the PUCCH format may be interpreted as a form of information. In addition, the PUCCH format may be interpreted as a set of information set for a certain form of information.

The PUSCH may be used for conveying one or both of a transport block and uplink control information. The transport block may be mapped to the PUSCH. The transport block delivered by the UL-SCH may be mapped to the PUSCH. The uplink control information may be mapped to the PUSCH. The terminal apparatus 1 may transmit the PUSCH to which one or both of the transport block and the uplink control information are mapped. The base station apparatus 3 may receive the PUSCH to which one or both of the transport block and the uplink control information are mapped.

The PRACH may be transmitted for conveying a random access preamble. The terminal apparatus 1 may transmit the PRACH. The base station apparatus 3 may receive the PRACH. A PRACH sequence x_{u,v}(n) is defined by x_{u,v}(n)=xᵤ(mod(n+Cᵥ, L_{RA})). Here, xᵤ is a Zadoff Chu (ZC) sequence. In addition, xᵤ may be defined by xᵤ=exp(−jπui(i+1)/L_{RA}). j is an imaginary unit. In addition, π is the circular constant. In addition, Cᵥ corresponds to a cyclic shift of the PRACH sequence. In addition, L_{RA} corresponds to the length of the PRACH sequence. In addition, L_{RA} is 839, or 139. In addition, i is an integer in the range from 0 to L_{RA}−1. In addition, u is a sequence index for the PRACH sequence.

For each PRACH occasion, 64 random access preambles are defined. The random access preambles are identified based on the cyclic shift C, of the PRACH sequence and the sequence index u for the PRACH sequence. Each of the 64 identified random access preambles may be assigned an index.

The uplink physical signal may correspond to a set of resource elements. The uplink physical signal need not be used to convey information generated in a higher layer. Further, an uplink physical signal may be used to convey information generated in the physical layer. The uplink physical signal may be a physical signal used in an uplink component carrier. The terminal apparatus 1 may transmit the uplink physical signal. The base station apparatus 3 may receive the uplink physical signal. In the radio communication system according to an aspect of the present embodiment, at least some or all of the following uplink physical signals may be used.
UpLink Demodulation Reference Signal (UL DMRS)
Sounding Reference Signal (SRS)
UpLink Phase Tracking Reference Signal (UL PTRS)

The UL DMRS is a general term for a DMRS for the PUSCH and a DMRS for the PUCCH.

A set of antenna ports of the DMRS for the PUSCH (DMRS related to the PUSCH, DMRS included in the PUSCH, DMRS corresponding to the PUSCH) may be given based on a set of antenna ports for the PUSCH. For example, the set of antenna ports of the DMRS for the PUSCH may be the same as a set of antenna ports of the PUSCH.

Transmission of the PUSCH and transmission of the DMRS for the PUSCH may be indicated (or may be scheduled) in one DCI format. The PUSCH and the DMRS for the PUSCH may be collectively referred to as a PUSCH. Transmission of the PUSCH may mean transmission of the PUSCH and the DMRS for the PUSCH.

A propagation path of the PUSCH may be inferred from the DMRS for the PUSCH.

A set of antenna ports of the DMRS for the PUCCH (DMRS related to the PUCCH, DMRS included in the PUCCH, or DMRS corresponding to the PUCCH) may be the same as a set of antenna ports of the PUCCH.

Transmission of the PUCCH and transmission of the DMRS for the PUCCH may be indicated (or may be triggered) by one DCI format. One or both of mapping of the PUCCH to resource elements and mapping of the DMRS for the PUCCH to resource elements may be given in one PUCCH format. The PUCCH and the DMRS for the PUCCH may be collectively referred to as a PUCCH. Transmission of the PUCCH may mean transmission of the PUCCH and the DMRS for the PUCCH.

A propagation path of the PUCCH may be inferred from the DMRS for the PUCCH.

The downlink physical channel may correspond to a set of resource elements for conveying information generated in a higher layer. The downlink physical channel may be a physical channel used in a downlink component carrier. The base station apparatus 3 may transmit the downlink physical channel. The terminal apparatus 1 may receive the downlink physical channel. In the radio communication system according to an aspect of the present embodiment, at least some or all of the following downlink physical channels may be used.
Physical Broadcast Channel (PBCH)
Physical Downlink Control Channel (PDCCH)
Physical Downlink Shared Channel (PDSCH)

The PBCH may be transmitted for conveying one or both of a Master Information Block (MIB) and physical layer control information. Here, the physical layer control information is information generated in the physical layer. The MIB is a set of parameters mapped to a Broadcast Control CHannel (BCCH) that is a logical channel of the MAC layer. The BCCH is mapped in the BCH that is a channel of the transport layer. The BCH may be mapped to the PBCH. The terminal apparatus 1 may receive the PBCH to which one or both of the MIB and the physical layer control information are mapped. The base station apparatus 3 may transmit the PBCH to which one or both of the MIB and the physical layer control information are mapped.

For example, the physical layer control information may include 8 bits. The physical layer control information may include at least some or all of the following 0A to 0D.
0A) Radio frame bit
0B) Half radio frame (half system frame or half frame) bit
0C) SS/PBCH block index bit
0D) Subcarrier offset bit

The radio frame bit is used for indicating a radio frame in which the PBCH is transmitted (radio frame including a slot in which the PBCH is transmitted). The radio frame bit includes 4 bits. The radio frame bit may include 4 bits out of a 10-bit radio frame indicator. For example, the radio frame indicator may be at least used for identifying radio frames from index 0 to index 1023.

The half radio frame bit is used for indicating, out of the radio frame in which the PBCH is transmitted, which of the first five subframes or the last five subframes is used for transmission of the PBCH. Here, the half radio frame may include five subframes. In addition, the half radio frame may include the first five subframes out of the 10 subframes included in the radio frame. In addition, the half radio frame may include the last five subframes out of the 10 subframes included in the radio frame.

An SS/PBCH block index bit is used for indicating an SS/PBCH block index. The SS/PBCH block index bit includes 3 bits. The SS/PBCH block index bit may include 3 bits out of a 6-bit SS/PBCH block index indicator. The SS/PBCH block index indicator may be at least used for identifying SS/PBCH blocks from index 0 to index 63.

A subcarrier offset bit is used for indicating a subcarrier offset. The subcarrier offset may be used for indicating a difference between a first subcarrier to which the PBCH is mapped and a first subcarrier to which the control resource set having an index 0 is mapped.

The PDCCH may be transmitted for delivering Downlink Control Information (DCI). The downlink control information may be mapped to the PDCCH. The terminal apparatus 1 may receive the PDCCH to which the downlink control information is mapped. The base station apparatus 3 may transmit the PDCCH to which the downlink control information is mapped.

The downlink control information may be transmitted with a DCI format. Further, the DCI format may also be interpreted as the format of downlink control information. In addition, the DCI format may be interpreted as a set of downlink control information set to a certain format of downlink control information.

A DCI format 0_0, a DCI format 0_1, a DCI format 1_0, and a DCI format 1_1 are DCI formats. An uplink DCI format is a general term for the DCI format 0_0 and the DCI format 0_1. A downlink DCI format is a general term for the DCI format 1_0 and the DCI format 1_1.

The DCI format 0_0 is at least used for scheduling of the PUSCH mapped to a certain cell. The DCI format 0_0 includes at least some or all of fields listed from 1A to 1E.
1A) Identifier field for DCI formats
1B) Frequency domain resource assignment field
1C) Time domain resource assignment field
1D) Frequency hopping flag field
1E) Modulation and Coding Scheme (MCS) field

The identifier field for DCI formats may indicate whether the DCI format including the identifier field for DCI formats is an uplink DCI format or a downlink DCI format. In other words, each of the uplink DCI format and the downlink DCI format may include the identifier field for DCI formats. Here, the identifier field for DCI formats included in the DCI format 0_0 may indicate 0.

A frequency domain resource assignment field included in the DCI format 0_0 may be used for indicating assignment of frequency resources for the PUSCH.

A time domain resource assignment field included in the DCI format 00 may be used for indicating assignment of time resources for the PUSCH.

A frequency hopping flag field may be used for indicating whether frequency hopping is applied to the PUSCH.

An MCS field included in the DCI format 0_0 may be at least used for indicating one or both of a modulation scheme for the PUSCH and a target encoding rate. The target encoding rate may be a target encoding rate for a transport block mapped to the PUSCH. A Transport Block Size (TBS) of a transport block mapped to the PUSCH may be determined based on one or both of the target encoding rate and the modulation scheme for the PUSCH.

The DCI format 0_0 need not include a field used for a CSI request.

The DCI format 0_0 need not include a carrier indicator field. In other words, the serving cell to which an uplink component carrier belongs, the uplink component carrier to which the PUSCH scheduled by the DCI format 0_0 is mapped, may be the same as the serving cell of an uplink component carrier to which the PDCCH including the DCI format 00 is mapped. Based on detection of the DCI format 0_0 in a certain downlink component carrier of a certain serving cell, the terminal apparatus 1 may recognize that the PUSCH scheduled by the DCI format 0_0 is mapped to the uplink component carrier of the certain serving cell.

The DCI format 0_0 need not include the BWP field. Here, the DCI format 0_0 may be a DCI format for scheduling the PUSCH without changing the active uplink BWP. The terminal apparatus 1 may recognize that the PUSCH is transmitted without switching the active uplink BWP based on detection of the DCI format 0_0 used for the scheduling of the PUSCH.

The DCI format 0_1 is at least used for scheduling of the PUSCH mapped to a certain cell. The DCI format 0_1 includes at least some or all of fields listed from 2A to 2H.
2A) Identifier field for DCI formats
2B) Frequency domain resource assignment field
2C) Uplink time domain resource assignment field
2D) Frequency hopping flag field
2E) MCS field
2F) CSI request field
2G) BWP field
2H) Carrier indicator field

The identifier field for DCI formats included in the DCI format 0_1 may indicate 0.

The frequency domain resource assignment field included in the DCI format 01 may be used for indicating assignment of frequency resources for the PUSCH.

The time domain resource assignment field included in the DCI format 0_1 may be used for indicating assignment of time resources for the PUSCH.

The MCS field included in the DCI format 0_1 may be at least used for indicating some or all of a modulation scheme for the PUSCH and/or a target encoding rate.

The BWP field of the DCI format 01 may be used for indicating an uplink BWP to which the PUSCH scheduled by the DCI format 01 is mapped. In other words, the DCI format 0_1 may be accompanied by a change in the active uplink BWP. The terminal apparatus 1 may recognize the uplink BWP to which the PUSCH is mapped based on detection of the DCI format 0_1 used for scheduling of the PUSCH.

The DCI format 0_1 not including the BWP field may be a DCI format for scheduling the PUSCH without changing the active uplink BWP. The terminal apparatus 1 may recognize that the PUSCH is transmitted without switching the active uplink BWP based on detection of a DCI format D0_1 which is the DCI format 0_1 used for the scheduling of the PUSCH and does not include the BWP field.

In a case that the BWP field is included in the DCI format 0_1 but the terminal apparatus 1 does not support the function of switching the BWP according to the DCI format 0_1, the terminal apparatus 1 may disregard the BWP field. In other words, the terminal apparatus 1 which does not support the function of switching the BWP may recognize that the PUSCH is transmitted without switching the active uplink BWP based on detection of the DCI format 0_1 which is the DCI format 0_1 used for the scheduling of the PUSCH and includes the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

The CSI request field is used for indicating the report of the CSI.

In a case that the carrier indicator field is included in the DCI format 0_1, the carrier indicator field may be used for indicating the uplink component carrier to which the PUSCH is mapped. In a case that the carrier indicator field is not included in the DCI format 0_1, the uplink component carrier to which the PUSCH is mapped may be the same as the uplink component carrier to which the PDCCH including the DCI format 0_1 used for scheduling of the PUSCH is mapped. In a case that the number of uplink component carriers configured for the terminal apparatus 1 in a certain serving cell group is two or more (case that uplink carrier aggregation is operated in a certain serving cell group), the number of bits of the carrier indicator field included in the DCI format 0_1 used for scheduling of the PUSCH mapped to the certain serving cell group may be 1 bit or more (for example, 3 bits). In a case that the number of uplink component carriers configured for the terminal apparatus 1 in a certain serving cell group is one (case that uplink carrier aggregation is not operated in a certain serving cell group), the number of bits of the carrier indicator field included in the DCI format 0_1 used for scheduling of the PUSCH mapped to the certain serving cell group may be 0 bits (or the carrier indicator field need not be included in the DCI format 0_1 used for scheduling of the PUSCH mapped to the certain serving cell group).

The DCI format 1_0 is at least used for scheduling of the PDSCH mapped to a certain cell. The DCI format 1_0 includes at least a some or all of 3A to 3F.
3A) Identifier field for DCI formats
3B) Frequency domain resource assignment field
3C) Time domain resource assignment field
3D) MCS field
3E) PDSCH to HARQ feedback timing indicator field
3F) PUCCH resource indicator field

The identifier field for DCI formats included in the DCI format 1_0 may indicate 1.

The frequency domain resource assignment field included in the DCI format 10 may be at least used for indicating assignment of frequency resources for the PDSCH.

The time domain resource assignment field included in the DCI format 1_0 may be at least used for indicating assignment of time resources for the PDSCH.

The MCS field included in the DCI format 1_0 may be at least used for indicating one or both of the modulation scheme for the PDSCH and the target encoding rate. The target encoding rate may be a target encoding rate for the transport block mapped to the PDSCH. The Transport Block Size (TBS) of the transport block mapped to the PDSCH may be determined based on one or both of the target encoding rate and the modulation scheme for the PDSCH.

The PDSCH to HARQ feedback timing indicator field may be used for indicating an offset from the slot including the last OFDM symbol of the PDSCH to the slot including the first OFDM symbol of the PUCCH.

The PUCCH resource indicator field may be a field indicating an index of any one of one or multiple PUCCH resources included in a PUCCH resource set. The PUCCH resource set may include one or multiple PUCCH resources.

The DCI format 1_0 need not include the carrier indicator field. In other words, the downlink component carrier to which the PDSCH scheduled by the DCI format 1_0 is mapped may be the same as the downlink component carrier to which the PDCCH including the DCI format 1_0 is mapped. Based on detection of the DCI format 1_0 in a certain downlink component carrier, the terminal apparatus 1 may recognize that the PDSCH scheduled by the DCI format 1_0 is mapped to the downlink component carrier.

The DCI format 1_0 need not include the BWP field. Here, the DCI format 1_0 may be a DCI format for scheduling the PDSCH without changing the active downlink BWP. The terminal apparatus 1 may recognize that the PDSCH is received without switching the active downlink BWP based on detection of the DCI format 1_0 used in the scheduling of the PDSCH.

The DCI format 1_1 is at least used for scheduling of the PDSCH mapped to a certain cell. The DCI format 1_1 includes at least some or all of 4A to 4I.
4A) Identifier field for DCI formats
4B) Frequency domain resource assignment field
4C) Time domain resource assignment field
4E) MCS field
4F) PDSCH to HARQ feedback timing indicator field
4G) PUCCH resource indicator field
4H) BWP field
4I) Carrier indicator field

The identifier field for DCI formats included in the DCI format 1_1 may indicate 1.

The frequency domain resource assignment field included in the DCI format 11 may be at least used for indicating assignment of frequency resources for the PDSCH.

The time domain resource assignment field included in the DCI format 1_1 may be at least used for indicating assignment of time resources for the PDSCH.

The MCS field included in the DCI format 1_1 may be at least used for indicating one or both of the modulation scheme for the PDSCH and the target encoding rate.

In a case that the PDSCH to HARQ feedback timing indicator field is included in the DCI format 1_1, the PDSCH to HARQ feedback timing indicator field may be at least used for indicating an offset from the slot including the last OFDM symbol of the PDSCH to the slot including the first OFDM symbol of the PUCCH. In a case that the PDSCH to HARQ feedback timing indicator field is not included in the DCI format 1_1, an offset from the slot including the last OFDM symbol of the PDSCH to the slot including the first OFDM symbol of the PUCCH may be identified by a parameter of a higher layer.

The PUCCH resource indicator field may be a field indicating an index of any one of one or multiple PUCCH resources included in a PUCCH resource set.

The BWP field of the DCI format 11 may be used to indicate the downlink BWP to which the PDSCH scheduled by the DCI format 11 is mapped. In other words, the DCI format 1_1 may be accompanied by a change in the active downlink BWP. The terminal apparatus 1 may recognize the downlink BWP to which the PUSCH is mapped based on detection of the DCI format 1_1 used for the scheduling of the PDSCH.

The DCI format 1_1 not including the BWP field may be a DCI format for scheduling the PDSCH without changing the active downlink BWP. The terminal apparatus 1 may recognize that the PDSCH is received without switching the active downlink BWP based on detection of the DCI format 1_1 which is used for the scheduling of the PDSCH and does not include the BWP field.

In a case that the DCI format 1_1 includes the BWP field but the terminal apparatus 1 does not support the function of switching the BWP according to the DCI format 11, the terminal apparatus 1 may disregard the BWP field. In other words, the terminal apparatus 1 which does not support the function of switching the BWP may recognize that the PDSCH is received without switching the active downlink BWP based on detection of the DCI format 1_1 which is used for the scheduling of the PDSCH and includes the BWP field. Here, in a case that the terminal apparatus 1 supports the function of switching the BWP, the terminal apparatus 1 may report, in a function information reporting procedure of the RRC layer, that “the terminal apparatus 1 supports the function of switching the BWP”.

In a case that the carrier indicator field is included in the DCI format 1_1, the carrier indicator field may be used for indicating the downlink component carrier to which the PDSCH is mapped. In a case that the carrier indicator field is not included in the DCI format 1_1, the downlink component carrier to which the PDSCH is mapped may be the same as the downlink component carrier to which the PDCCH including the DCI format 1_1 used for scheduling of the PDSCH is mapped. In a case that the number of downlink component carriers configured for the terminal apparatus 1 in a certain serving cell group is two or more (case that downlink carrier aggregation is operated in a certain serving cell group), the number of bits of the carrier indicator field included in the DCI format 1_1 used for scheduling of the PDSCH mapped to the certain serving cell group may be 1 bit or more (for example, 3 bits). In a case that the number of downlink component carriers configured for the terminal apparatus 1 in a certain serving cell group is one (case that downlink carrier aggregation is not operated in a certain serving cell group), the number of bits of the carrier indicator field included in the DCI format 1_1 used for scheduling of the PDSCH mapped to the certain serving cell group may be 0 bits (or the carrier indicator field need not be included in the DCI format 1_1 used for scheduling of the PDSCH mapped to the certain serving cell group).

The PDSCH may be transmitted for conveying a transport block. The PDSCH may be used for transmitting the transport block delivered on the DL-SCH. The PDSCH may be used for conveying the transport block. The transport block may be mapped to the PDSCH. The transport block corresponding to the DL-SCH may be mapped to the PDSCH. The base station apparatus 3 may transmit the PDSCH. The terminal apparatus 1 may receive the PDSCH.

The downlink physical signal may correspond to a set of resource elements. The downlink physical signal need not carry information generated in a higher layer. The downlink physical signal may be a physical signal used in the downlink component carrier. The downlink physical signal may be transmitted by the base station apparatus 3. The downlink physical signal may be transmitted by the terminal apparatus 1. In the radio communication system according to an aspect of the present embodiment, at least some or all of the following downlink physical signals may be used.
Synchronization signal (SS)
DownLink DeModulation Reference Signal (DL DMRS)
Channel State Information-Reference Signal (CSI-RS)
DownLink Phase Tracking Reference Signal (DL PTRS)

The synchronization signal may be used for the terminal apparatus 1 to take synchronization in one or both of the frequency domain and the time domain in downlink. The synchronization signal is a general term for Primary Synchronization Signal (PSS) and Secondary Synchronization Signal (SSS).

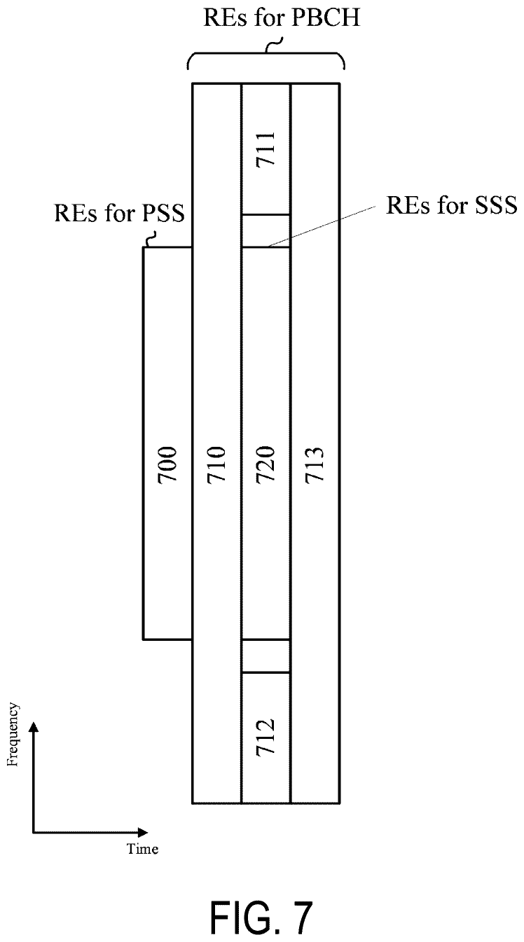

FIG. 7 is a diagram illustrating a configuration example of SS/PBCH blocks according to an aspect of the present embodiment. In FIG. 7, the horizontal axis corresponds to time axis (OFDM symbol index l_{sym}), and the vertical axis represents frequency domain. In addition, a block 700 represents a set of resource elements for the PSS. In addition, a block 720 represents a set of resource elements for the SSS. In addition, four blocks (blocks 710, 711, 712, and 713) represent a set of resource elements for the PBCH and the DMRS for the PBCH (DMRS related to the PBCH, DMRS included in the PBCH, and DMRS corresponding to the PBCH).

As illustrated in FIG. 7, the SS/PBCH blocks include the PSS, the SSS, and the PBCH. In addition, the SS/PBCH blocks include four consecutive OFDM symbols. The SS/PBCH blocks include 240 subcarriers. The PSS is mapped to the 57th to 183rd subcarriers of the first OFDM symbol. The SSS is mapped to the 57th to 183rd subcarriers of the third OFDM symbol. Zero may be set to the 1st to 56th subcarriers of the first OFDM symbol. Zero may be set to the 184th to 240th subcarriers of the first OFDM symbol. Zero may be set to the 49th to 56th subcarriers of the third OFDM symbol. Zero may be set to the 184th to 192nd subcarriers of the third OFDM symbol. The PBCH is mapped to subcarriers which are the 1st to 240th subcarriers of the second OFDM symbol and to which the DMRS for the PBCH is not mapped. The PBCH is mapped to subcarriers which are the 1st to 48th subcarriers of the third OFDM symbol and to which the DMRS for the PBCH is not mapped. The PBCH is mapped to subcarriers which are the 193rd to 240th subcarriers of the third OFDM symbol and to which the DMRS for the PBCH is not mapped. The PBCH is mapped to subcarriers which are the 1st to 240th subcarriers of the fourth OFDM symbol and to which the DMRS for the PBCH is not mapped.

Antenna ports of the PSS, the SSS, the PBCH, and the DMRS for the PBCH may be the same.

The PBCH over which the symbol of the PBCH on a certain antenna port is conveyed may be inferred from the DMRS for the PBCH mapped to the slot to which the PBCH is mapped and the DMRS for the PBCH included in the SS/PBCH blocks including the PBCH.

The DL DMRS is a general term for a DMRS for the PBCH, a DMRS for the PDSCH, and a DMRS for the PDCCH.

A set of antenna ports of the DMRS for the PDSCH (DMRS related to the PDSCH, DMRS included in the PDSCH, DMRS corresponding to the PDSCH) may be given based on a set of antenna ports for the PDSCH. In other words, the set of antenna ports of the DMRS for the PDSCH may be the same as the set of antenna ports for the PDSCH.

Transmission of the PDSCH and transmission of the DMRS for the PDSCH may be indicated (or may be scheduled) in one DCI format. The PDSCH and the DMRS for the PDSCH may be collectively referred to as PDSCHs. Transmission of the PDSCH may be transmission of the PDSCH and the DMRS for the PDSCH.

A propagation path of the PDSCH may be inferred from the DMRS for the PDSCH. In a case that a set of resource elements in which a symbol of a certain PDSCH is conveyed and a set of resource elements in which a symbol of the DMRS for the certain PDSCH is conveyed are included in the same Precoding Resource Group (PRG), the PDSCH over which the symbol of the PDSCH on a certain antenna port is conveyed may be inferred from the DMRS for the PDSCH.

The antenna port of the DMRS for the PDCCH (DMRS related to the PDCCH, DMRS included in the PDCCH, or DMRS corresponding to the PDCCH) may be the same as the antenna port for the PDCCH.

The PDCCH may be inferred from the DMRS for the PDCCH. In other words, a propagation path of the PDCCH may be inferred from the DMRS for the PDCCH. In a case that the same precoder is (assumed to be) applied to a set of resource elements in which the symbol of a certain PDCCH is conveyed and a set of resource elements in which the symbol of the DMRS for the certain PDCCH is conveyed, the PDCCH over which the symbol of the PDCCH on a certain antenna port is conveyed may be inferred from the DMRS for the PDCCH.

A Broadcast CHannel (BCH), an UpLink-Shared CHannel (UL-SCH), and a Downlink-Shared CHannel (DL-SCH) are transport channels. A transport channel defines the relationship between a physical layer channel and a MAC layer channel (also referred to as a logical channel).

The BCH of the transport layer is mapped to the PBCH of the physical layer. In other words, a transport block conveyed on the BCH of the transport layer is delivered to the PBCH of the physical layer. In addition, the UL-SCH of the transport layer is mapped to the PUSCH of the physical layer. In other words, the transport block conveyed on the UL-SCH of the transport layer is delivered to the PUSCH of the physical layer. In addition, the DL-SCH of the transport layer is mapped to the PDSCH of the physical layer. In other words, the transport block conveyed on the DL-SCH of the transport layer is delivered to the PDSCH of the physical layer.

One UL-SCH and one DL-SCH may be given to each serving cell. The BCH may be given to a PCell. The BCH need not be given to a PSCell and a SCell.

The MAC layer controls a Hybrid Automatic Repeat reQuest (HARQ) for each transport block.

A Broadcast Control CHannel (BCCH), a Common Control CHannel (CCCH), and a Dedicated Control CHannel (DCCH) are logical channels. For example, the BCCH is a channel of the RRC layer used for transmitting a MIB or system information. In addition, the Common Control CHannel (CCCH) may be used for transmitting a common RRC message by multiple terminal apparatuses 1. Here, the CCCH may be, for example, used for the terminal apparatus 1 that is not in am RRC connection. In addition, the Dedicated Control CHannel (DCCH) may be at least used for transmitting an RRC message dedicated to the terminal apparatus 1. Here, the DCCH may be, for example, used for the terminal apparatus 1 that is in an RRC connection.

A higher layer parameter common to multiple terminal apparatuses 1 is also referred to as a common higher layer parameter. Here, a common higher layer parameter may be defined as a parameter unique to a serving cell. Here, the parameter unique to the serving cell may be a parameter common to terminal apparatuses configured by the serving cell (for example, terminal apparatuses 1-A, 1-B, and 1-C).

For example, an RRC message delivered to the BCCH may include the common higher layer parameter. For example, an RRC message delivered on the DCCH may include the common higher layer parameter.

Among certain higher layer parameters, a higher layer parameter different from the common higher layer parameter is also referred to as a dedicated higher layer parameter. Here, the dedicated higher layer parameter may provide a dedicated RRC parameter to the terminal apparatus 1-A configured by the serving cell. In other words, the dedicated RRC parameter is a higher layer parameter capable of providing a unique configuration to each of the terminal apparatuses 1-A, 1-B, and 1-C.

The BCCH of a logical channel may be mapped to the BCH or the DL-SCH of the transport layer. For example, a transport block including the information of the MIB is delivered to the BCH of the transport layer. In addition, a transport block including system information other than the MIB is delivered to the DL-SCH of the transport layer. In addition, the CCCH is mapped to the DL-SCH or the UL-SCH. In other words, a transport block mapped to the CCCH is delivered to the DL-SCH or the UL-SCH. In addition, the DCCH is mapped to the DL-SCH or the UL-SCH. In other words, a transport block mapped to the DCCH is delivered to the DL-SCH or the UL-SCH.

The RRC message includes one or multiple parameters managed in the RRC layer. Here, the parameters managed in the RRC layer are also referred to as RRC parameters. For example, the RRC message may include the MIB. In addition, the RRC message may include the system information. In addition, the RRC message may include a message corresponding to the CCCH. In addition, the RRC message may include a message corresponding to the DCCH. The RRC message including a message corresponding to the DCCH is also referred to as a dedicated RRC message.

The higher layer parameter (a parameter of a higher layer) is an RRC parameter or a parameter included in a Medium Access Control Control Element (MAC CE). In other words, the higher layer parameter is a general term for the MIB, the system information, a message corresponding to the CCCH, a message corresponding to the DCCH, and parameters included in the MAC CE. The parameters included in the MAC CE are transmitted by a MAC Control Element (CE) command.

Procedures performed by the terminal apparatus 1 include at least some or all of the following 5A to 5C.
5A) Cell search
5B) Random access
5C) Data communication

Cell search is a procedure used for the terminal apparatus 1 synchronizing with a certain cell related to the time domain and the frequency domain and detecting a physical cell identity (physical cell ID). In other words, by means of cell search, the terminal apparatus 1 may perform synchronization with a certain cell in the time domain and the frequency domain and detect a physical cell ID.

A sequence of the PSS is given based at least on the physical cell ID. A sequence of the SSS is given based at least on the physical cell ID.

An SS/PBCH block candidate indicates a resource allowed to (being able to, scheduled to, configured to, defined to, or having a possibility to) transmit a SS/PBCH block.

A set of SS/PBCH block candidates in a certain half radio frame is also referred to as an SS burst set. An SS burst set is also referred to as a transmission window, an SS transmission window, or a Discovery Reference Signal transmission window (DRS transmission window). An SS burst set is a general term including at least a first SS burst set and a second SS burst set.

The base station apparatus 3 transmits SS/PBCH blocks with one or multiple indices at a prescribed periodicity. The terminal apparatus 1 may detect at least one SS/PBCH block out of the SS/PBCH blocks with one or multiple indices and attempt decoding of the PBCH included in the SS/PBCH block.

Random access is a procedure including at least some or all of a message 1, a message 2, a message 3, and a message 4.

The message 1 is a procedure in which the PRACH is transmitted by the terminal apparatus 1. The terminal apparatus 1 transmits the PRACH in one PRACH occasion selected out of one or multiple PRACH occasions based at least on the index of an SS/PBCH block candidate detected based on cell search. Each of the PRACH occasions is defined based at least on resources of the time domain and the frequency domain.

The terminal apparatus 1 transmits one random access preamble selected out of the PRACH occasions corresponding to the indices of the SS/PBCH block candidates in which the SS/PBCHs blocks are detected.

The message 2 is a procedure for attempting to detect a DCI format 1_0 with Cyclic Redundancy Check (CRC) scrambled by a Random Access-Radio Network Temporary Identifier (RA-RNTI) by the terminal apparatus 1. The terminal apparatus 1 attempts detection of the PDCCH including the DCI format in a control resource set given based on the MIB, which is included in the PBCH included in the SS/PBCH block detected based on cell search, and in resources indicated based on a configuration of a search space set. The message 2 is also referred to as a random access response.

The message 3 is a procedure for transmitting the PUSCH scheduled by using a random access response grant included in the DCI format 1_0 detected through the procedure of the message 2. Here, the random access response grant is indicated by a MAC CE included in the PDSCH scheduled by using the DCI format 1_0.

The PUSCH scheduled based on the random access response grant is either a message 3 PUSCH or a PUSCH. The message 3 PUSCH includes a contention resolution identifier (contention resolution ID) MAC CE. The contention resolution ID MAC CE includes a contention resolution ID.

Retransmission of the message 3 PUSCH is scheduled by using a DCI format 0_0 with a CRC scrambled based on a Temporary Cell-Radio Network Temporary Identifier (TC-RNTI).

The message 4 is a procedure for attempting to detect the DCI format 1_0 with a CRC scrambled based on either of a Cell-Radio Network Temporary Identifier (C-RNTI) or a TC-RNTI. The terminal apparatus 1 receives a PDSCH scheduled based on the DCI format 1_0. The PDSCH may include a contention resolution ID.

Data communication is a general term for downlink communication and uplink communication.

In data communication, the terminal apparatus 1 attempts detection of the PDCCH (monitors the PDCCH or supervises the PDCCH) in a control resource set and resources identified based on a search space set.

The control resource set is a set of resources including a certain number of resource blocks and a certain number of OFDM symbols. In the frequency domain, the control resource set may include consecutive resources (non-interleaved mapping) or may include distributed resources (interleaver mapping).

A set of resource blocks constituting the control resource set may be indicated by the higher layer parameter. The number of OFDM symbols constituting the control resource set may be indicated by the higher layer parameter.

The terminal apparatus 1 attempts detection of the PDCCH in a search space set. Here, an attempt to detect the PDCCH in the search space set may be an attempt to detect a candidate of the PDCCH in the search space set, may be an attempt to detect a DCI format in the search space set, may be an attempt to detect the PDCCH in the control resource set, may be an attempt to detect a candidate of the PDCCH in the control resource set, or may be an attempt to detect a DCI format in the control resource set.

The search space set is defined as a set of candidates for the PDCCH. The search space set may be a Common Search Space (CSS) set or may be a UE-specific Search Space (USS) set. The terminal apparatus 1 attempts detection of candidates for the PDCCH in some or all of a Type 0 PDCCH common search space set, a Type 0a PDCCH common search space set, a Type 1 PDCCH common search space set, a Type 2 PDCCH common search space set, a Type 3 PDCCH common search space set, and/or a UE-specific PDCCH search space set (UE-specific search space set).

The Type 0 PDCCH common search space set may be used as a common search space set having an index 0. The Type 0 PDCCH common search space set may be a common search space set having the index 0.

A CSS set is a general term for the Type 0 PDCCH common search space set, the Type 0a PDCCH common search space set, the Type 1 PDCCH common search space set, the Type 2 PDCCH common search space set, and the Type 3 PDCCH common search space set. A USS set is also referred to as a UE-specific PDCCH search space set.

A certain search space set is related to (is included in or corresponds to) a certain control resource set. An index of a control resource set related to a search space set may be indicated by a higher layer parameter.

For a certain search space set, some or all of 6A to 6C may be indicated by at least a higher layer parameter.
6A) PDCCH monitoring periodicity
6B) PDCCH monitoring pattern within a slot
6C) PDCCH monitoring offset

A monitoring occasion of a certain search space set may correspond to an OFDM symbol to which the first OFDM symbol of a control resource set related to the certain search space set is mapped. The monitoring occasion of the certain search space set may correspond to a resource of the control resource set starting from the first OFDM symbol of the control resource set related to the certain search space set. The monitoring occasion of the search space set is given based at least on some or all of the monitoring periodicity of the PDCCH, the monitoring pattern of the PDCCH in a slot, and the monitoring offset of the PDCCH.

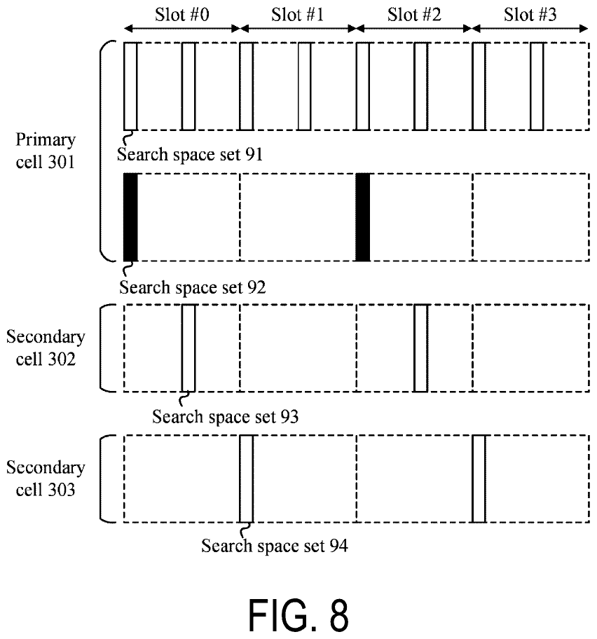

FIG. 8 is a diagram illustrating an example of monitoring occasions for search space sets according to an aspect of the present embodiment. In FIG. 8, a search space set 91 and a search space set 92 are configured in a primary cell 301, a search space set 93 is configured in a secondary cell 302, and a search space set 94 is configured in a secondary cell 303.

In FIG. 8, solid white blocks in the primary cell 301 represent a search space set 91, solid black blocks in the primary cell 301 represent a search space set 92, blocks in the secondary cell 302 represent a search space set 93, and blocks in the secondary cell 303 represent a search space set 94.

The monitoring periodicity of the search space set 91 is set to one slot, the monitoring offset of the search space set 91 is set to zero slots, and the monitoring pattern of the search space set 91 is set to [1, 0, 0, 0, 0, 0, 0, 1, 0, 0, 0, 0, 0, 0]. In other words, the monitoring occasion for the search space set 91 corresponds to the first OFDM symbol (OFDM symbol #0) and the eighth OFDM symbol (OFDM symbol #7) in each of the slots.

The monitoring periodicity of the search space set 92 is set to two slots, the monitoring offset of the search space set 92 is set to zero slots, and the monitoring pattern of the search space set 92 is set to [1, 0, 0, 0, 0, 0, 0, 0, 0, 0, 0, 0, 0, 0]. In other words, the monitoring occasion for the search space set 92 corresponds to the first OFDM symbol (OFDM symbol #0) in each of the even-numbered slots.

The monitoring periodicity of the search space set 93 is set to two slots, the monitoring offset of the search space set 93 is set to zero slots, and the monitoring pattern of the search space set 93 is set to [0, 0, 0, 0, 0, 0, 0, 1, 0, 0, 0, 0, 0, 0]. In other words, the monitoring occasion for the search space set 93 corresponds to the eighth OFDM symbol (OFDM symbol #7) in each of the even-numbered slots.

The monitoring periodicity of the search space set 94 is set to two slots, the monitoring offset of the search space set 94 is set to one slot, and the monitoring pattern of the search space set 94 is set to [1, 0, 0, 0, 0, 0, 0, 0, 0, 0, 0, 0, 0, 0]. In other words, the monitoring occasion for the search space set 94 corresponds to the first OFDM symbol (OFDM symbol #0) in each of the odd-numbered slots.

The Type 0 PDCCH common search space set may be at least used for the DCI format with a Cyclic Redundancy Check (CRC) sequence scrambled by a System Information-Radio Network Temporary Identifier (SI-RNTI).

The Type 0a PDCCH common search space set may be at least used for the DCI format with a Cyclic Redundancy Check (CRC) sequence scrambled by a System Information-Radio Network Temporary Identifier (SI-RNTI).

The Type 1 PDCCH common search space set may be at least used for the DCI format with a CRC sequence scrambled by a Random Access-Radio Network Temporary Identifier (RA-RNTI) and/or a CRC sequence scrambled by a Temporary Cell-Radio Network Temporary Identifier (TC-RNTI).

The Type 2 PDCCH common search space set may be used for the DCI format with a CRC sequence scrambled by a Paging-Radio Network Temporary Identifier (P-RNTI).

The Type 3 PDCCH common search space set may be used for the DCI format with a CRC sequence scrambled by a Cell-Radio Network Temporary Identifier (C-RNTI).

The UE-specific PDCCH search space set may be at least used for the DCI format with a CRC sequence scrambled by a C-RNTI.

In downlink communication, the terminal apparatus 1 detects a downlink DCI format. The detected downlink DCI format is at least used for PDSCH resource assignment. The detected downlink DCI format is also referred to as a downlink assignment. The terminal apparatus 1 attempts reception of the PDSCH. Based on the PUCCH resource indicated based on the detected downlink DCI format, a HARQ-ACK corresponding to the PDSCH (HARQ-ACK corresponding to the transport block included in the PDSCH) is reported to the base station apparatus 3.

In uplink communication, the terminal apparatus 1 detects an uplink DCI format. The detected DCI format is at least used for resource assignment of the PUSCH. The detected uplink DCI format is also referred to as an uplink grant. The terminal apparatus 1 performs transmission of the PUSCH.

In configured scheduling (configured grant), an uplink grant for scheduling the PUSCH is configured for each transmission periodicity of the PUSCH. A part or all of pieces of information indicated by an uplink DCI format in a case that the PUSCH is scheduled by the uplink DCI format may be indicated by the uplink grant configured in a case of the configured scheduling.

PUSCH-Config may be a dedicated higher layer parameter. PUSCH-ConfigCommon may be a common higher layer parameter. PUSCH-Config may be configured per BWP for PUSCH transmission. PUSCH-Config may include multiple higher layer parameters related to the PUSCH transmission. PUSCH-Config may be a UE-specific configuration. For example, PUSCH-Config parameters or multiple higher layer parameters included in PUSCH-Config may be different among the terminal apparatus 1A, and the terminal apparatus 1B, the terminal apparatus 1C in one cell. PUSCH-ConfigCommon may be configured per BWP for the PUSCH transmission. PUSCH-ConfigCommon may include multiple higher layer parameters related to the PUSCH transmission. PUSCH-ConfigCommon may be a cell-specific configuration. For example, PUSCH-ConfigCommon for the terminal apparatus 1A, and the terminal apparatus 1B, the terminal apparatus 1C in one cell may be common. For example, PUSCH-ConfigCommon may be provided in system information.

Repetition transmission may be applied to the PUSCH scheduled by DCI. In addition, repetition transmission may be applied to the PUSCH scheduled by a configured uplink grant. A PUSCH repetition type may be one of a PUSCH repetition type A and a PUSCH repetition type B. The PUSCH repetition type may be configured by a higher layer parameter. The PUSCH repetition type may be based on the DCI format. For example, the first PUSCH repetition type for the PUSCH scheduled by the DCI format 0_1 may be different from the second PUSCH repetition type for the PUSCH scheduled by a DCI format 0_2.

The number of repetitions for PUSCH repetition transmission may be configured by a higher layer parameter. For example, the higher layer parameter numberOfRepetitions may be a parameter including the number of repetitions for the PUSCH repetition transmission. For the PUSCH repetition transmission corresponding to the PUSCH repetition type A, the number of repetitions for the PUSCH repetition transmission may be determined according to the value of the higher layer parameter numberOfRepetitions. In the PUSCH repetition type A, for the PUSCH for which transmission is indicated by the DCI format with the CRC scrambled by any one of a C-RNTI, and an MCS-C-RNTI, and a CS-RNTI, in a case that a resource assignment table includes numberOfRepetitions, the number of repetitions may be equal to numberOfRepetitions. In a case that one PUSCH-TimeDomainResourceAllocation includes one or multiple PUSCH-Allocations, the higher layer parameter numberOfRepetitions may be configured for each PUSCH-Allocation. In addition, PUSCH-TimeDomainResourceAllocation may be referred to as a resource assignment table.

The higher layer parameter pusch-AggregationFactor may be a parameter indicating the number of repetitions for the PUSCH repetition transmission. For the PUSCH repetition transmission corresponding to the PUSCH repetition type A, the number of repetitions for the PUSCH repetition transmission may be determined according to the value of the higher layer parameter pusch-AggregationFactor. In the PUSCH repetition type A, for the PUSCH for which transmission is indicated by the DCI format with the CRC scrambled by any one of a C-RNTI, and an MCS-C-RNTI, and a CS-RNTI, in a case that pusch-AggregationFactor is configured, the number of repetitions may be equal to pusch-AggregationFactor. pusch-AggregationFactor may be configured for PUSCH-Config.

The number of repetitions corresponding to the PUSCH repetition type A may be the number of slots for the PUSCH repetition transmission. In addition, one TB may be repeated in one or multiple slots. Assignment of the same OFDM symbol may be applied to PUSCH repetitions transmitted in different slots.

The PUSCH repetition transmission corresponding to the PUSCH repetition type B may be based on a Nominal Repetition and an Actual Repetition.

A scheme for frequency hopping may be configured by a higher layer parameter. Higher layer parameters frequencyHopping, frequencyHoppingDCI-0-1, and frequencyHoppingDCI-0-2 may be parameters for providing a frequency hopping scheme for the PUSCH. For example, the frequency hopping scheme corresponding to the frequency hopping for the PUSCH may be configured by frequencyHoppingDCI-0-2 in PUSCH-Config. In addition, the frequency hopping scheme corresponding to the frequency hopping for the PUSCH may be configured by frequencyHopping in PUSCH-Config. In addition, the frequency hopping scheme corresponding to the frequency hopping for the PUSCH transmission configured by frequencyHopping in configuredGrantConfig may be configured. The frequency hopping scheme may be any one of intra-slot frequency hopping, inter-slot frequency hopping, inter-repetition frequency hopping, and inter-bundle frequency hopping. In addition, the frequency hopping interval corresponding to the intra-slot frequency hopping may be within one slot. The frequency hopping interval corresponding to the inter-slot frequency hopping may be one slot. The frequency hopping interval corresponding to the inter-repetition frequency hopping may be based on nominal repetition. The frequency hopping interval corresponding to the inter-bundle frequency hopping may be one or multiple slots. For example, one or multiple slots may be consecutive. A Bundle may be a unit of time including multiple slots. For example, the multiple slots may be consecutive. A bundle may be the number of slots corresponding to a frequency hopping interval. A bundle may be referred to as a Hopping Interval. In a case that a frequency hopping interval for frequency hopping is one slot or more, the frequency hopping may be referred to as inter-bundle frequency hopping. In a case that a frequency hopping interval for frequency hopping is greater than one slot, the frequency hopping may be referred to as inter-bundle frequency hopping.

For example, in a case that a first higher layer parameter for providing the frequency hopping scheme for the PUSCH provides the inter-slot frequency hopping and a hopping interval (or a bundle) is provided by a second higher layer parameter, the inter-bundle frequency hopping may be applied to the PUSCH. For example, in a case that the higher layer parameter for providing the frequency hopping scheme for the PUSCH provides the inter-bundle frequency hopping, the inter-bundle frequency hopping may be applied to the PUSCH.

For example, the hopping interval may be provided by a higher layer parameter. For example, the higher layer parameter may be a dedicated higher layer parameter. For example, in a case that the higher layer parameter provides a hopping interval N, a bundle of N slots may be applied for the PUSCH to which inter-bundle frequency hopping is applied. The N may be an integer greater than 1. For example, in a case that the higher layer parameter provides a hopping interval N, a bundle of N slots need not be applied for the PUSCH to which inter-bundle frequency hopping is not applied. For example, in a case that the higher layer parameter includes one value, the one value may be provided for one or both of the PUSCH and the PUCCH to which inter-bundle frequency hopping is applied. The one value may be an integer greater than 1. In addition, the one value may be a window length of a configured time domain window.

Whether to perform frequency hopping may be determined based at least on DCI. Whether to apply frequency hopping for the PUSCH over which transmission is indicated by the DCI format may be determined based at least on the value of a frequency hopping flag field included in the DCI format. Whether to apply frequency hopping for the PUSCH for which transmission is indicated by the random access response grant may be determined based at least on the value of the frequency hopping flag field included in the random access response grant. For example, the frequency hopping for the PUSCH may be performed based at least on the value of the frequency hopping flag field being 1.

In a case that the value of the frequency hopping flag field included in the DCI format is 1, frequency hopping for the PUSCH for which transmission is indicated by the DCI format need not be performed. For example, in a case that the value of the frequency hopping flag field provided by one or multiple higher layer parameter and included in the DCI format is 1, frequency hopping for the PUSCH for which transmission is indicated by the DCI format need not be performed. One of the one or multiple higher layer parameters may be a first higher layer parameter for determining whether DMRS bundling is applied. One of the one or multiple higher layer parameters may be a second higher layer parameter for determining a window length of a configured time domain window. One of the one or multiple higher layer parameters may be a third higher layer parameter for determining a hopping interval for frequency hopping. One of the one or multiple higher layer parameters may be a fourth higher layer parameter for determining a frequency hopping scheme for frequency hopping.

The intra-slot frequency hopping may be applied to PUSCH transmission in one or multiple slots. For example, the intra-slot frequency hopping may be applied to PUSCH repetition transmission. For the PUSCH to which the intra-slot frequency hopping is applied, mapping may be switched for each OFDM symbol or for every multiple OFDM symbols. For example, for the PUSCH to which the intra-slot frequency hopping is applied, mapping of the resource blocks may be switched for each OFDM symbol or for every multiple OFDM symbols between a first hop and a second hop. In addition, in a case that intra-slot frequency hopping is performed for the PUSCH, switching between the first hop and the second hop may be performed for each OFDM symbol or for every multiple OFDM symbols. There may be a difference of RB_{offset} between the position of the first resource block of the first hop and the position of the first resource block of the second hop. RB_{offset} may be configured by a higher layer parameter. The one or multiple OFDM symbols may be one slot or less. The one or multiple OFDM symbols may be half the number of OFDM symbols for the PUSCH in one slot. The intra-slot frequency hopping may be applied to the PUSCH corresponding to the PUSCH repetition type A.

The inter-slot frequency hopping may be applied to PUSCH transmission in multiple slots. For the PUSCH to which inter-slot frequency hopping is applied, mapping of the resource blocks may be switched for each slot. For example, the inter-slot frequency hopping may be applied to the PUSCH repetition transmission. In addition, in a case that the inter-slot frequency hopping is performed for the PUSCH, mapping of the resource blocks may be switched for every slot between the first hop and the second hop. For example, in a case that a certain slot has a slot index n^{μ}_{s,f} that is even-numbered, the PUSCH transmission in the slot may correspond to the first hop. For example, in a case that the certain slot has a slot index n^{μ}_{s,f} that is odd-numbered, the PUSCH transmission in the slot may correspond to the second hop. The inter-slot frequency hopping may be applied to the PUSCH corresponding to one of the PUSCH repetition type A and the PUSCH repetition type B.

The inter-repetition frequency hopping may be applied to the PUSCH corresponding to the PUSCH repetition type B. For the PUSCH to which the inter-repetition frequency hopping is applied, switching between the first hop and the second hop may be performed based on nominal repetition.

The inter-bundle frequency hopping may be applied to the PUSCH transmission in multiple slots. For example, the inter-bundle frequency hopping may be applied to the PUSCH repetition transmission. For the PUSCH to which inter-bundle frequency hopping is applied, mapping of the resource blocks may be switched for each bundle. In addition, in a case that the inter-bundle frequency hopping is performed for the PUSCH, mapping of resource blocks may be switched for every bundle between the first hop and the second hop. A bundle may be one or multiple slots. For example, a bundle may be determined by a higher layer parameter. For example, a bundle may be determined based on the number of repetitions. For example, a bundle may include consecutive UL slots. For example, a bundle may include a special slot and a UL slot. The inter-bundle frequency hopping may be applied to the PUSCH corresponding to one of the PUSCH repetition type A and the PUSCH repetition type B.

For the PUSCH to which inter-bundle frequency hopping is applied, mapping of the resource blocks may be switched based on the bundle and the slot index n^{μ}_{s,f}. For the PUSCH to which the inter-bundle frequency hopping is applied, mapping of resource blocks may be switched between the first hop and the second hop, based on the slot index n^{μ}_{s,f} and the bundle. For example, in a case that the bundle is N, a PUSCH repetition transmitted in slots corresponding to the n-th slot index to the (n+N−1)th slot index may correspond to one of the first hop and the second hop. n may be an integer equal to or greater than 0. N may be an integer equal to or greater than 1.

The UL slot may be a slot including UL symbols. The special slot may be a slot including a UL symbol, a flexible symbol, and a DL symbol. The DL slot may be a slot including DL symbols.

The UL symbol may be an OFDM symbol configured or indicated for uplink in time division duplex. The UL symbol may be an OFDM symbol configured or indicated for the PUSCH, the PUCCH, the PRACH, or the SRS. The UL symbol may be provided by a higher layer parameter tdd-UL-DL-ConfigurationCommon. The UL symbol may be provided by a higher layer parameter tdd-UL-DL-ConfigurationDedicated. The UL slot may be provided by the higher layer parameter tdd-UL-DL-ConfigurationCommon. The UL slot may be provided by the higher layer parameter tdd-UL-DL-ConfigurationDedicated.

The DL symbol may be an OFDM symbol configured or indicated for downlink in time division duplex. The DL symbol may be an OFDM symbol configured or indicated for the PDSCH or the PDCCH. The DL symbol may be provided by a higher layer parameter tdd-UL-DL-ConfigurationCommon. The DL symbol may be provided by a higher layer parameter tdd-UL-DL-ConfigurationDedicated. The DL slot may be provided by the higher layer parameter tdd-UL-DL-ConfigurationCommon. The DL slot may be provided by the higher layer parameter tdd-UL-DL-ConfigurationDedicated.

The flexible symbol may be an OFDM symbol that is not configured or indicated as a UL symbol or a DL symbol among the OFDM symbols within a certain periodicity. The certain periodicity may be a periodicity given by a higher layer parameter dl-UL-TransmissionPeriodicity. The flexible symbol may be an OFDM symbol configured or indicated for the PDSCH, the PDCCH, the PUSCH, the PUCCH, or the PRACH.

The higher layer parameter tdd-UL-DL-ConfigurationCommon may be a parameter for configuring any one of a UL slot, a DL slot, and a special slot for each of one or multiple slots. The higher layer parameter tdd-UL-DL-ConfigurationDedicated may be a parameter for configuring any one of a UL symbol, a DL symbol, and a flexible symbol for a flexible symbol in each of the one or multiple slots. tdd-UL-DL-ConfigurationCommon may be a common higher layer parameter. tdd-UL-DL-ConfigurationDedicated may be a dedicated higher layer parameter.

A Time Domain Window may indicate a time domain period. For example, the time domain window may be used for DMRS Bundling. The terminal apparatus 1 to which DMRS bundling is applied may enable channel estimation by using DMRSs included in two or more PUSCHs in a period based on the time domain window. The terminal apparatus 1 to which DMRS bundling is applied may be expected to maintain one or both of phase continuity and power consistency between two PUSCHs in the period based on the time domain window. DMRS bundling may be referred to as Joint Channel Estimation. Frequency hopping in the case that DMRS bundling is applied may be referred to as inter-bundle frequency hopping.

The time domain window may be a collective term for a Configured Time Domain Window and an Actual Time Domain Window. The configured time domain window may be referred to as a Nominal Time Domain Window.

Whether to apply DMRS bundling may be configured by a higher layer parameter. That DMRS bundling is applied may be that one or both of the configured time domain window and the actual time domain window are enabled. For example, that DMRS bundling is applied may be that a higher layer parameter PUSCH-DMRS-Bundling is provided. For example, that DMRS bundling is not applied may be that the higher layer parameter PUSCH-DMRS-Bundling is not provided.

The configured time domain window may include one or multiple consecutive slots. The configured time domain window may be configured by one or multiple higher layer parameters. For example, the one or multiple higher layer parameters may include one or multiple parameters that can enable the configured time domain window. For example, the one or multiple higher layer parameters may include one or multiple parameters indicating the length of the configured time domain window. The length of the configured time domain window may be referred to as a window length. The configured time domain window may include slots corresponding to the window length. A start position of the configured time domain window may be determined based on the first PUSCH of PUSCH repetition transmission. For example, the start position of the configured time domain window may be the first slot of the PUSCH repetition transmission. For example, the start position of the configured time domain window may be the first slot in which the PUSCH to which the PUSCH repetition type A is applied is transmitted. For example, the start position of the configured time domain window may be a slot corresponding to the first transmission occasion for the PUSCH to which the PUSCH repetition type A is applied. The length of the configured time domain window may be determined based on a window length. The length of the configured time domain window may be determined based at least on the number of repetitions of the PUSCH to which the configured time domain window is applied.

The window length may be provided by a higher layer parameter. The window length may be one or multiple slots. The window length may be one or multiple consecutive slots. In a case that the window length is provided, the configured time domain window may be determined based on the window length. The window length may be used as a bundle for inter-bundle frequency hopping. For example, one of the first hop and the second hop may correspond to multiple PUSCH transmission operations in the configured time domain window. Some or both of the configured time domain window and the window length may be used for precoding. For example, the same precoding may be applied to multiple PUSCH transmission operations in the configured time domain window. Some or both of the configured time domain window and the window length may be used for terminal adjustment of the terminal apparatus 1. For example, a shift in frequency synchronization in the configured time domain window need not be corrected. For example, in the configured time domain window, a shift in time synchronization need not be corrected. For example, antenna virtualization need not be adjusted in the configured time domain window. For example, an analog circuit controlled by digital signals in the configured time domain window need not be adjusted. For example, a high frequency circuit in the configured time domain window need not be adjusted. The adjustment of the high frequency circuit may include some or all of a change of an operating point in a power amplifier, a change of a gain in the power amplifier, phase synchronization in an oscillator, phase adjustment in two carriers, phase adjustment in a phase shifter, and suspending power supply to the high frequency circuit.

A length of the configured time domain window may have a predetermined maximum period. The window length may have a predetermined maximum period. For example, the terminal apparatus 1 may report the maximum period to the base station apparatus 3.

One or multiple window lengths may be configured in PUSCH-Config. In addition, one or multiple window lengths may be configured in PUSCH-ConfigCommon. For example, one of the one or multiple window lengths may be determined based on the DCI format. For example, one of the one or multiple window lengths may be determined based on a time domain resource assignment field included in the DCI.

In Frequency Division Duplex, two or more configured time domain windows may be consecutive. For example, the last slot in a first configured time domain window may be consecutive with the first slot in a second configured time domain window.

In time division duplex, two or more configured time domain windows may be consecutive. In addition, in time division duplex, two or more configured time domain windows need not be consecutive. For example, the start position of the configured time domain window may be determined based at least on one or both of tdd-UL-DL-ConfigurationCommon and tdd-UL-DL-ConfigurationDedicated. For example, the start position of the configured time domain window may include no DL slots.

The first configured time domain window of the one or multiple configured time domain windows may end immediately before a DL slot. In addition, configured time domain windows of the one or multiple configured time domain windows excluding the first configured time domain window may be aligned with a periodicity given dl-UL-TransmissionPeriodicity.

The configured time domain window may end based on a certain slot index. For example, in a case that n^{μ}_{s,f} is a first value, the configured time domain window may end at the end of the slot corresponding to n^{μ}_{s,f}. The configured time domain window may be applied to the PUSCH transmitted in the slot. The first value may be 0. The first value may be configured by a higher layer parameter. The first value may be determined based on a certain periodicity. For example, the certain periodicity may be used for processing to be performed at the certain periodicity. The certain periodicity may be an integer multiple of the window length of the configured time domain window. The first value may be determined by the certain periodicity and the offset. In addition, in a case that n^{μ}_{s,f} is the second value, the configured time domain window may end at the end of the slot corresponding to n^{μ}_{s,f}. The difference between the first value and the second value may be the certain periodicity.

The last one of the one or multiple configured time domain windows may end at the slot corresponding to the last PUSCH in the PUSCH repetition transmission.

One or more actual time domain windows may be determined in the configured time domain windows. The multiple actual time domain windows need not be consecutive with each other. The terminal apparatus 1 may be expected to maintain phase continuity and power consistency in the actual time domain windows. The actual time domain windows may include one or multiple slots. The actual time domain windows may include one or multiple OFDM symbols.

The actual time domain windows may be determined based on an event occurring within a configured time domain window. The actual time domain windows may be determined based on the slot or the OFDM symbol corresponding to the event in the configured time domain window. The actual time domain windows need not include the slot or the OFDM symbol corresponding to the event in the configured time domain window. For example, the event may include some or all of reception of a downlink physical channel, and transmission of a high-priority channel, a slot format indication, frequency hopping, and a cancellation indication.

For example, the slot or the OFDM symbol corresponding to the event may be a slot or an OFDM symbol in which PUSCH repetition transmission is canceled. For example, the slot corresponding to the event may be a DL slot. For example, the slot or the OFDM symbol corresponding to the event may be a slot or an OFDM symbol including a DL reception occasion. For example, the slot or the OFDM symbol corresponding to the event may be a slot or an OFDM symbol in which a high-priority channel is transmitted. For example, the slot corresponding to the event may be a slot indicated as a DL slot or a special slot by a slot format indication. For example, the OFDM symbol corresponding to the event may be an OFDM symbol indicated as a DL symbol or a flexible symbol by the slot format indication. For example, in a case that an (n−1)th slot is associated with the first hop, the slot corresponding to the event may be an n-th slot associated with the second hop. For example, in a case that the (n−1)th slot is associated with the second hop, the slot corresponding to the event may be the n-th slot associated with the first hop. For example, in a case that an (n−1)th OFDM symbol is associated with the first hop, the OFDM symbol corresponding to the event may be an n-th OFDM symbol associated with the second hop. For example, in a case that the (n−1)th slot is associated with the second hop, the OFDM symbol corresponding to the event may be the nth OFDM symbol associated with the first hop.

The actual time domain windows may include an OFDM symbol in which no PUSCH is transmitted. For example, the actual time domain windows may include 13 consecutive OFDM symbols, and the terminal apparatus 1 need not transmit an uplink physical channel and an uplink physical signal in the 13 consecutive OFDM symbols.

The terminal apparatus 1 may maintain phase continuity and transmission power consistency in the actual time domain windows based on requirements for phase continuity and transmission power consistency. For example, the terminal apparatus 1 may be expected to maintain phase continuity and transmission power consistency in the actual time domain windows. For example, in the actual time domain windows, two OFDM symbols in which an uplink physical channel and an uplink physical signal are transmitted may correspond to the same antenna port. For example, the terminal apparatus 1 may determine whether a first channel on which a symbol in a certain antenna port is conveyed should be transmitted to be estimated from a second channel on which another symbol in the certain antenna port is conveyed based on whether a certain actual time domain window includes the first channel and the second channel. For example, in a case that the certain actual time domain window includes the first channel and the second channel, the terminal apparatus 1 may transmit the first channel on which the symbol in the certain antenna port is conveyed to be estimated from the second channel on which the other symbol in the certain antenna port is conveyed. In addition, in a case that the certain actual time domain window does not include the first channel or the second channel, the terminal apparatus 1 need not transmit the first channel on which the symbol in the certain antenna port is conveyed to be estimated from the second channel on which the other symbol in the certain antenna port is conveyed. Here, the first channel may be different from the second channel. Alternatively, the first channel may be the same as the second channel. In addition, the first channel may be a certain Repetition of a third channel, and the second channel may be another repetition of the third channel. For example, the terminal apparatus 1 need not change the parameter related to precoding for the PUCCH and/or the PUSCH within the actual time domain window. For example, the parameter related to precoding may be a precoding matrix for spatial multiplexing. In addition, the parameter related to precoding may be a higher layer parameter txConfig. In addition, the parameter related to precoding may be a Transmitted Precoding Matrix Indicator (TPMI). The TPMI may be given in the DCI format. In addition, the parameter related to precoding may be an SRS Resource Indicator (SRI). In addition, the terminal apparatus 1 may apply one precoding operation to the repetition of the PUSCH in the actual time domain window. For example, power control may be performed for the first PUSCH in the actual time domain window. In addition, power need not be controlled for one or multiple PUSCHs except for the first PUSCH in the actual time domain window. For example, the value of a TPC command field may be applied for the first PUSCH in the actual time domain window. In addition, the value of the TPC command field need not be applied for one or multiple PUSCHs except for the first PUSCH in the actual time domain window. The TPC command field for the PUSCH may be included in some or all of the DCI format 0_0, the DCI format 01, the DCI format 0_2, the DCI format 2_2, the DCI format 2_3, and a random access response grant. In addition, the terminal apparatus 1 need not perform frequency hopping for a repetition of the PUSCH in the actual time domain window. Not performing the frequency hopping may mean that a repetition of the PUCCH in the actual time domain window is at least provided to one of the first hop or the second hop. In addition, the terminal apparatus 1 need not perform beam switching on the PUSCH within the actual time domain window. In addition, the terminal apparatus 1 need not change configuration of the modulation scheme and the modulation order for the PUSCH transmission in the actual time domain window. In addition, the terminal apparatus 1 need not change the index of the first resource block and the number of resource blocks for PUSCH transmission in the actual time domain window. In addition, one or multiple PUSCHs within the actual time domain window may correspond to the same time domain resource assignment. In addition, the same precoding may be applied to one or multiple PUSCHs within the actual time domain window. In addition, the same transmission power control may be applied to one or multiple PUSCHs within the actual time domain window. In addition, one or multiple PUSCHs within the actual time domain window may be at least mapped to the same resource block. In addition, the terminal apparatus 1 may transmit a baseband signal with an amplitude of 0 between two non-consecutive PUSCHs within the actual time domain window.

Whether DMRS bundling is to be applied may be provided by a first higher layer parameter. The window length for the configured time domain window may be provided by a second higher layer parameter. A hopping interval for frequency hopping may be provided by a third higher layer parameter. A frequency hopping scheme for frequency hopping may be provided by a fourth higher layer parameter. The first higher layer parameter, the first higher layer parameter, the second higher layer parameter, the third higher layer parameter, and the fourth higher layer parameter may be different higher layer parameters.

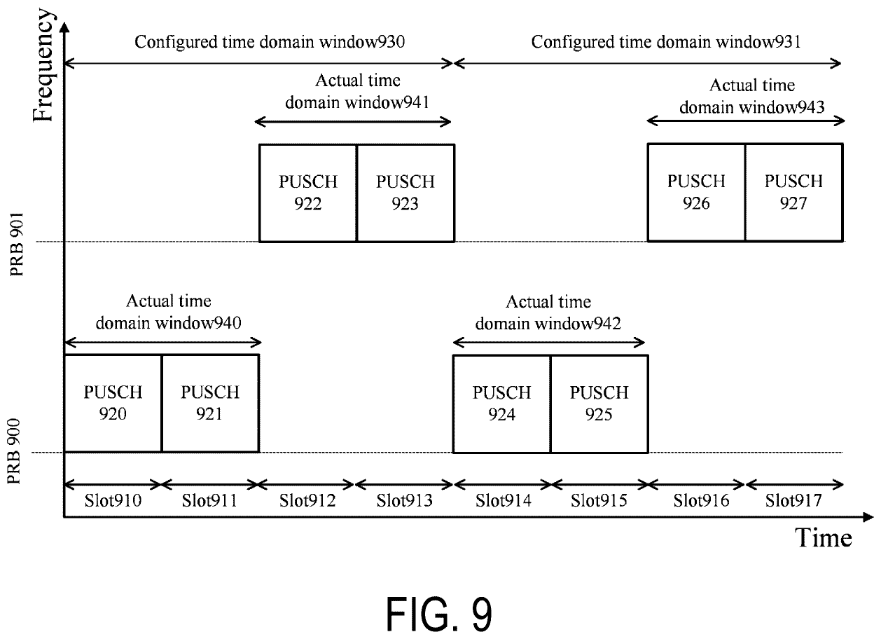

FIG. 9 is a diagram illustrating an example of inter-bundle frequency hopping independent of configured time domain windows according to an aspect of the present embodiment. In an uplink BWP on an uplink carrier, the terminal apparatus 1 transmits a PUSCH 920 in a slot 910, transmits a PUSCH 921 in a slot 911, transmits a PUSCH 922 in a slot 912, transmits a PUSCH 923 in a slot 913, transmits a PUSCH 924 in a slot 914, transmits a PUSCH 925 in a slot 915, transmits a PUSCH 926 in a slot 916, and transmits a PUSCH 927 in a slot 917.

In FIG. 9, a configured time domain window 930 includes the PUSCH 920, the PUSCH 921, the PUSCH 922, and the PUSCH 923. A configured time domain window 931 includes the PUSCH 924, the PUSCH 925, the PUSCH 926, and the PUSCH 927. An actual time domain window 940 includes the PUSCH 920 and the PUSCH 921. An actual time domain window 941 includes the PUSCH 922 and the PUSCH 923. An actual time domain window 942 includes the PUSCH 924 and the PUSCH 925. An actual time domain window 943 includes the PUSCH 926 and the PUSCH 927. For example, a length of each configured time domain window in FIG. 9 may be 4. In addition, the length may be provided by a higher layer parameter.

The PUSCH 920, the PUSCH 921, the PUSCH 922, the PUSCH 923, the PUSCH 924, the PUSCH 925, the PUSCH 926, and the PUSCH 927 may indicate PUSCH repetition transmission. For example, the number of repetitions corresponding to the PUSCH repetition transmission in FIG. 9 may be 8. For example, the PUSCH repetition transmission in FIG. 9 may correspond to the PUSCH repetition type A.

The PUSCH 920, the PUSCH 921, the PUSCH 924, and the PUSCH 925 are mapped to the resource block including a PRB 900. The PUSCH 922, the PUSCH 923, the PUSCH 926, and the PUSCH 927 are mapped to the resource block including a PRB 901. For example, a hopping interval for frequency hopping in FIG. 9 may be 2. For example, a slot 910 may correspond to a slot index 0. For example, a hopping interval for frequency hopping may be provided by a higher layer parameter.

No frequency hopping may be performed in the slot 911, frequency hopping may be performed in the slot 912, no frequency hopping may be performed in the slot 911, frequency hopping may be performed in the slot 912, no frequency hopping may be performed in the slot 911, frequency hopping may be performed in the slot 912, and no frequency hopping may be performed in the slot 911.

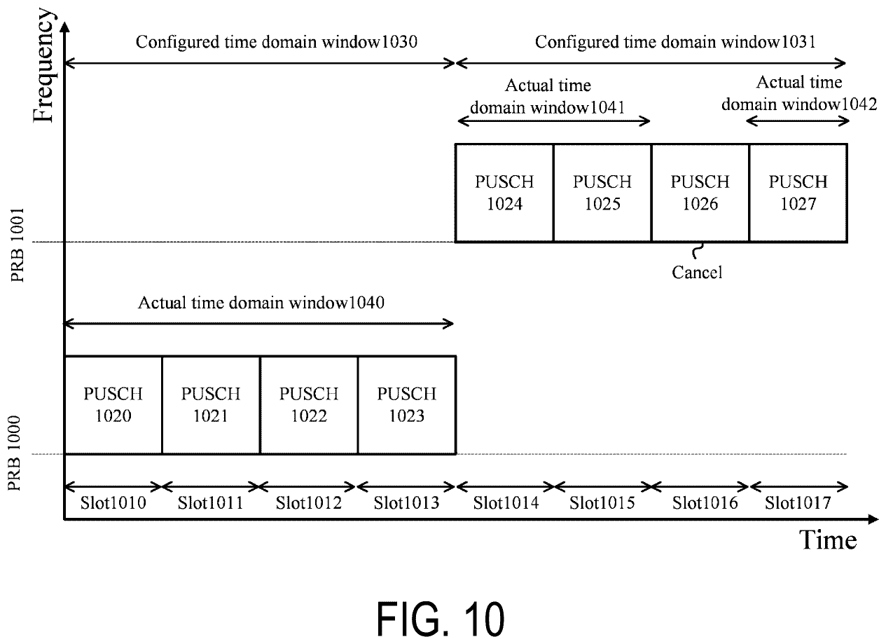

FIG. 10 is a diagram illustrating an example of inter-bundle frequency hopping dependent on configured time domain windows according to an aspect of the present embodiment. In an uplink BWP on an uplink carrier, the terminal apparatus 1 transmits a PUSCH 1020 in a slot 1010, transmits a PUSCH 1021 in a slot 1011, transmits a PUSCH 1022 in a slot 1012, transmits a PUSCH 1023 in a slot 1013, transmits a PUSCH 1024 in a slot 1014, transmits a PUSCH 1025 in a slot 1015, and transmits a PUSCH 1027 in a slot 1017. The terminal apparatus 1 need not transmit the PUSCH 1026 in the slot 1016.

In FIG. 10, a configured time domain window 1030 includes the PUSCH 1020, the PUSCH 1021, the PUSCH 1022, and the PUSCH 1023. A configured time domain window 1031 includes the PUSCH 1024, the PUSCH 1025, the PUSCH 1026, and the PUSCH 1027. An actual time domain window 1040 includes the PUSCH 1020, the PUSCH 1021, the PUSCH 1022, and the PUSCH 1023. An actual time domain window 1041 includes the PUSCH 1024 and the PUSCH 1025. An actual time domain window 942 includes the PUSCH 1027.

The PUSCH 1020, the PUSCH 1021, the PUSCH 1022, the PUSCH 1023. the PUSCH 1024, the PUSCH 1025, the PUSCH 1026, and the PUSCH 1027 may be PUSCH repetition transmission. For example, the number of repetitions corresponding to the PUSCH repetition transmission in FIG. 10 may be 8. For example, the PUSCH repetition transmission in FIG. 10 may correspond to the PUSCH repetition type A.

The PUSCH 1020, the PUSCH 1021, the PUSCH 1022, and the PUSCH 1023 are mapped to the resource block including a PRB 1000. The PUSCH 1024, the PUSCH 1025, the PUSCH 1026, and the PUSCH 1027 are mapped to the resource block including a PRB 1001. For example, a hopping interval for frequency hopping in FIG. 10 may be 4. For example, the hopping interval for frequency hopping may be the same as the length of a configured time domain window. For example, the hopping interval for frequency hopping may be the same as the length of the configured time domain window. For example, the PUSCHs in the configured time domain windows may correspond to one of the first hop and the second hop.

The PUSCH 1026 need not be transmitted in the slot 1016. For example, the PUSCH 1026 may overlap with an uplink channel having a high priority. For example, cancellation of the transmission of the PUSCH 1026 may be indicated. For example, the slot 1016 may be a slot corresponding to an event.

For example, in a case that a first higher layer parameter for enabling DMRS bundling is provided, a second higher layer parameter for determining a configured time domain window is provided, and a third higher layer parameter is provided, a hopping interval corresponding to frequency hopping for the PUSCH may be determined based at least on the third higher layer parameter. However, in order to perform communication efficiently, a hopping interval of frequency hopping may be determined based at least on a combination of the first higher layer parameter, the second higher layer parameter, and the third higher layer parameter. Means 1 may be used to determine hopping of frequency hopping based at least on the combination. For example, the efficient communication may mean that a DMRS bundling gain is increased. For example, the efficient communication may mean that a large number of terminal apparatuses are multiplexed.

In Means 1, the first higher layer parameter may be a higher layer parameter for determining whether DMRS bundling is enabled. The first higher layer parameter may be a higher layer parameter for determining whether DMRS bundling is applied for a PUSCH.

In Means 1, the second higher layer parameter may be a higher layer parameter used in determination of a configured time domain window. For example, the second higher layer parameter may be a higher layer parameter that provides a window length.

In Means 1, the third higher layer parameter may be a higher layer parameter used to determine a hopping interval for frequency hopping. For example, the third higher layer parameter may provide a bundle for inter-bundle frequency hopping. For example, the third higher layer parameter may provide a hopping interval for frequency hopping.

In Means 1, a hopping interval for frequency hopping may be determined based at least on a combination of some or all of whether the first higher layer parameter is provided, whether the second higher layer parameter is provided, and whether the third higher layer parameter is provided.

For example, a hopping interval for frequency hopping may be determined based at least on a combination of whether the first higher layer parameter is provided, whether the second higher layer parameter is provided, and whether the third higher layer parameter is provided.

In Means 1, frequency hopping may be applied for the PUSCH. For example, in Means 1, frequency hopping may be applied for the PUSCH based at least on DCI. For example, in Means 1, the value of the frequency hopping flag field included in the DCI indicating transmission of the PUSCH may be 1. In Means 1, a frequency hopping scheme for frequency hopping may be provided by a fourth higher layer parameter. For example, in Means 1, one of inter-slot frequency hopping and inter-bundle frequency hopping may be enabled by the fourth higher layer parameter. For example, in Means 1, the frequency hopping scheme corresponding to the frequency hopping for the PUSCH may be determined based at least on the DCI format indicating transmission of the PUSCH.

For example, in a case that the first higher layer parameter and the third higher layer parameter are provided in Means 1, the hopping interval corresponding to the frequency hopping for the PUSCH may be determined based on the third higher layer parameter. That is, in a case that DMRS bundling is applied to the PUSCH and the hopping interval corresponding to the frequency hopping for the PUSCH is provided by a higher layer parameter, the hopping interval may be applied.

For example, in a case that the first higher layer parameter and the second higher layer parameter are provided and the third higher layer parameter is not provided in Means 1, the hopping interval may be determined based at least on the second higher layer parameter. For example, the hopping interval in FIG. 10 may be determined based on the second higher layer parameter. That is, in a case that DMRS bundling is applied to the PUSCH, a window length is provided for a configured time domain window for the DMRS bundling, and a hopping interval for frequency hopping for the PUSCH is not provided by a higher layer parameter, the hopping interval for frequency hopping may be the same as the window length.

For example, in a case that the second higher layer parameter is provided and the first higher layer parameter and the third higher layer parameter are not provided in Means 1, the hopping interval for frequency hopping may be one slot. The hopping scheme corresponding to the frequency hopping may be inter-slot frequency hopping. That is, in a case that DMRS bundling is not applied to the PUSCH, a window length is provided, and a hopping interval for frequency hopping is not provided by a higher layer parameter, the frequency hopping may be inter-slot frequency hopping.

For example, in a case that the first higher layer parameter is not provided in Means 1, the hopping interval corresponding to the frequency hopping for the PUSCH may be one slot. The frequency hopping scheme corresponding to the frequency hopping may be inter-slot frequency hopping.

For example, in a case that the first higher layer parameter is provided and the second higher layer parameter and the third higher layer parameter are not provided in Means 1, the hopping interval corresponding to frequency hopping may be one slot. The frequency hopping scheme corresponding to the frequency hopping may be inter-slot frequency hopping.

For example, in a case that the first higher layer parameter is provided and the second higher layer parameter and the third higher layer parameter are not provided in Means 1, the hopping interval for frequency hopping may be one value. The one value may be the same as a length of a configured time domain window. The one value may be half a length of a configured time domain window. The one value may be the same as the number of repetitions of the PUSCH to which frequency hopping is applied. The one value may be half the number of repetitions of the PUSCH to which frequency hopping is applied. The one value may be the same as the maximum length of a configured time domain window. The one value may be half the maximum length of the configured time domain window. The one value may be the number of slots equal to or greater than two. For example, the one value may be two slots. For example, the one value may be five slots.

For example, in a case that the first higher layer parameter, the second higher layer parameter, and the third higher layer parameter are not provided in Means 1, the hopping interval for frequency hopping may be one slot.

For example, in a case that any one of the first higher layer parameter, the second higher layer parameter, and the third higher layer parameter is provided in Means 1, the hopping interval for frequency hopping may be greater than one slot.

For example, in Means 1, one or more combinations among combinations of whether the first higher layer parameter is provided, whether the second higher layer parameter is provided, and whether the third higher layer parameter is provided need not be expected. For example, the terminal apparatus 1 need not expect the one or multiple combinations. For example, the base station apparatus 3 need not perform configuration by a higher layer parameter to have the one or multiple combinations. One of the one or multiple combinations may be a combination in which the first higher layer parameter is provided and the second higher layer parameter and the third higher layer parameter are not provided. One of the one or multiple combinations may be a combination in which the first higher layer parameter is not provided and the second higher layer parameter and the third higher layer parameter are provided. One of the one or multiple combinations may be a combination in which the first higher layer parameter and the third higher layer parameter are not provided and the second higher layer parameter is provided. One of the one or multiple combinations may be a combination in which the first higher layer parameter and the second higher layer parameter are not provided and the third higher layer parameter is provided. Provision of higher layer parameters corresponding to the one or multiple combinations need not be expected. Alternatively, in a case that the higher layer parameters corresponding to the one or multiple combinations are provided, the terminal apparatus 1 need not expect application of frequency hopping.

For example, in Means 1, frequency hopping for the PUSCH need not be applied based on a combination of whether the first higher layer parameter is provided, whether the second higher layer parameter is provided, and whether the third higher layer parameter is provided. For example, in a case that the first higher layer parameter is provided and the second higher layer parameter and the third higher layer parameter are not provided, frequency hopping need not be applied.

Various aspects of apparatuses according to an aspect of the present embodiment will be described below.

(1) In order to accomplish the object described above, an aspect of the present invention is contrived to provide the following means. That is, a first aspect of the present invention is a terminal apparatus including a receiver that receives a PDCCH including DCI indicating transmission of a PUSCH, a transmitter that transmits the PUSCH, and a higher layer processing unit that manages a first higher layer parameter, a second higher layer parameter, and a third higher layer parameter, in which frequency hopping is applied for the PUSCH based at least on the DCI, the first higher layer parameter is a higher layer parameter for determining whether DMRS bundling is enabled for the PUSCH, the second higher layer parameter is a higher layer parameter used for determining a configured time domain window, in a case that the first higher layer parameter and the third higher layer parameter are provided, a hopping interval for the frequency hopping is determined based on the third higher layer parameter, and the hopping interval is determined based at least on a combination of whether the first higher layer parameter is provided, whether the second higher layer parameter is provided, and whether the third higher layer parameter is provided. In a case that the first higher layer parameter and the second higher layer parameter are provided and the third higher layer parameter is not provided, the hopping interval may be determined based on the second higher layer parameter, and in a case that the second higher layer parameter is provided and the first higher layer parameter and the third higher layer parameter is not provided, the hopping interval may be one slot. In a case that the first higher layer parameter is not provided, the hopping interval may be one slot, and in a case that the first higher layer parameter is provided and the second higher layer parameter and the third higher layer parameter are not provided, the hopping interval may be one slot. In a case that the first higher layer parameter is provided and the second higher layer parameter and the third higher layer parameter are not provided, the hopping interval may be one of two slots and five slots. In a case that the first higher layer parameter is provided and the second higher layer parameter and the third higher layer parameter are not provided, the hopping interval may be determined based at least on the number of repetitions for the PUSCH. In a case that any of the first higher layer parameter, the second higher layer parameter, and the third higher layer parameter is provided, the hopping interval may be greater than one slot. One or multiple combinations among the combinations of whether the first higher layer parameter is provided, whether the second higher layer parameter is provided, and whether the third higher layer parameter is provided need not be expected.

(2) A second aspect of the present invention is a base station apparatus including a transmitter that transmits a PDCCH including DCI indicating transmission of a PUSCH, a receiver that receives the PUSCH, and a higher layer processing unit that manages a first higher layer parameter, a second higher layer parameter, and a third higher layer parameter, in which frequency hopping is applied for the PUSCH based at least on the DCI, the first higher layer parameter is a higher layer parameter for determining whether DMRS bundling is enabled for the PUSCH, the second higher layer parameter is a higher layer parameter used for determining a configured time domain window, in a case that the first higher layer parameter and the third higher layer parameter are provided, a hopping interval for the frequency hopping is determined based on the third higher layer parameter, and the hopping interval is determined based at least on a combination of whether the first higher layer parameter is provided, whether the second higher layer parameter is provided, and whether the third higher layer parameter is provided. In a case that the first higher layer parameter and the second higher layer parameter are provided and the third higher layer parameter is not provided, the hopping interval may be determined based on the second higher layer parameter, and in a case that the second higher layer parameter is provided and the first higher layer parameter and the third higher layer parameter is not provided, the hopping interval may be one slot. In a case that the first higher layer parameter is not provided, the hopping interval may be one slot, and in a case that the first higher layer parameter is provided and the second higher layer parameter and the third higher layer parameter are not provided, the hopping interval may be one slot. In a case that the first higher layer parameter is provided and the second higher layer parameter and the third higher layer parameter are not provided, the hopping interval may be one of two slots and five slots. In a case that the first higher layer parameter is provided and the second higher layer parameter and the third higher layer parameter are not provided, the hopping interval may be determined based at least on the number of repetitions for the PUSCH. In a case that any of the first higher layer parameter, the second higher layer parameter, and the third higher layer parameter is provided, the hopping interval may be greater than one slot. One or multiple combinations among the combinations of whether the first higher layer parameter is provided, whether the second higher layer parameter is provided, and whether the third higher layer parameter is provided need not be expected.

A program running on the base station apparatus 3 and the terminal apparatus 1 according to an aspect of the present invention may be a program (a program that causes a computer to function) that controls a Central Processing Unit (CPU) and the like so as to implement the functions of the above-described embodiment according to an aspect of the present invention. The information handled in these apparatuses is temporarily loaded into a Random Access Memory (RAM) while being processed, is then stored in a Hard Disk Drive (HDD) and various types of Read Only Memory (ROM) such as a Flash ROM, and is read, modified, and written by the CPU, as necessary.

Note that the terminal apparatus 1 and the base station apparatus 3 according to the above-described embodiment may be partially implemented by a computer. In that case, this configuration may be implemented by recording a program for implementing such control functions on a computer-readable recording medium and causing a computer system to read the program recorded on the recording medium for execution.

Note that it is assumed that the “computer system” mentioned here refers to a computer system built into the terminal apparatus 1 or the base station apparatus 3, and the computer system includes an OS and hardware components such as peripheral devices. A “computer-readable recording medium” refers to a portable medium such as a flexible disk, a magneto-optical disk, a ROM, and a CD-ROM, and a storage apparatus such as a hard disk built into the computer system.

Moreover, the “computer-readable recording medium” may include a medium that dynamically stores a program for a short period of time, such as a communication line in a case that the program is transmitted over a network such as the Internet or over a communication line such as a telephone line, and may also include a medium that stores the program for a certain period of time, such as a volatile memory included in the computer system functioning as a server or a client in such a case. The above-described program may be one for implementing a part of the above-described functions, and also may be one capable of implementing the above-described functions in combination with a program already recorded in a computer system.

Furthermore, the base station apparatus 3 according to the aforementioned embodiment may be implemented as an aggregation (apparatus group) including multiple apparatuses. Each of the apparatuses included in such an apparatus group may include a part or all of each function or each functional block of the base station apparatus 3 according to the aforementioned embodiment. As the apparatus group, it is only necessary to have all of functions or functional blocks of the base station apparatus 3. Moreover, the terminal apparatus 1 according to the aforementioned embodiment can also communicate with the base station apparatus as the aggregation.

Also, the base station apparatus 3 according to the aforementioned embodiment may be an Evolved Universal Terrestrial Radio Access Network (EUTRAN) and/or a NextGen RAN (NG-RAN or NR RAN). Moreover, the base station apparatus 3 according to the aforementioned embodiment may have a part or all of the functions of a higher node for an eNodeB and/or a gNB.

Also, a part or all portions of each of the terminal apparatus 1 and the base station apparatus 3 according to the aforementioned embodiment may be implemented as an LSI, which is typically an integrated circuit, or may be implemented as a chip set. The functional blocks of each of the terminal apparatus 1 and the base station apparatus 3 may be individually implemented as a chip, or a part or all of the functional blocks may be integrated into a chip. Furthermore, a circuit integration technique is not limited to the LSI and may be implemented with a dedicated circuit or a general-purpose processor. Moreover, in a case that a circuit integration technology that substitutes an LSI appears with the advance of the semiconductor technology, it is also possible to use an integrated circuit based on the technology.

In addition, although the aforementioned embodiments have described the terminal apparatus as an example of a communication apparatus, the present invention is not limited to such a terminal apparatus, and is also applicable to a terminal apparatus or a communication apparatus that is a stationary type or a non-movable type electronic apparatus installed indoors or outdoors, for example, such as an AV device, a kitchen device, a cleaning or washing machine, an air-conditioning device, office equipment, a vending machine, and other household appliances.

Although, the embodiments of the present invention have been described in detail above referring to the drawings, the specific configuration is not limited to the embodiments and includes, for example, design changes within the scope that does not depart from the gist of the present invention. For an aspect of the present invention, various modifications are possible within the scope of the claims, and embodiments that are made by suitably combining technical means disclosed according to the different embodiments are also included in the technical scope of the present invention. In addition, a configuration in which elements described in the respective embodiments and having mutually the similar effects are substituted for one another is also included.

### INDUSTRIAL APPLICABILITY

An aspect of the present invention can be utilized, for example, in a communication system, communication equipment (for example, a cellular phone apparatus, a base station apparatus, a wireless LAN apparatus, or a sensor device), an integrated circuit (for example, a communication chip), or a program.

### REFERENCE SIGNS LIST

1 (1A, 1B, 11C) Terminal apparatus
3 Base station apparatus
10, 30 Radio transmission and/or reception unit
10a, 30a Radio transmitter
10b, 30b Radio receiver
11, 31 Antenna unit
12, 32 RF unit
13, 33 Baseband unit
14, 34 Higher layer processing unit
15, 35 Medium access control layer processing unit
16, 36 Radio resource control layer processing unit
91, 92, 93, 94 Search space set
300 Component carrier
301 Primary cell
302, 303 Secondary cell
700 Set of resource elements for PSS
710, 711, 712, 713 Set of resource elements for PBCH and DMRS for PBCH
720 Set of resource elements for SSS
3000 Point
3001, 3002 Resource grid
3003, 3004 BWP
3011, 3012, 3013, 3014 Offset
3100, 3200 Common resource block set
900, 901, 1000, 1001 PRB
910, 911, 912, 913, 914, 915, 916, 917, 1010, 1011, 1012, 1013, 1014, 1015, 1016, 1017 Slot
920, 921, 922, 923, 924, 925, 926, 927, 1020, 1021, 1022, 1023, 1024, 1025, 1026, 1027 PUSCH
930, 931, 1030, 1031 Configured time domain window
940, 941, 942, 943, 1040, 1041, 1042 Actual time domain window

1. A terminal apparatus comprising:
a receiver configured to receive a PDCCH to which DCI for scheduling a PUSCH is mapped;
a transmitter configured to transmit the PUSCH; and
a higher layer processing unit configured to manage a first higher layer parameter, a second higher layer parameter, and a third higher layer parameter, wherein
frequency hopping is applied for the PUSCH based at least on the DCI,
the first higher layer parameter is a higher layer parameter for providing whether DMRS bundling for the PUSCH is enabled,
the second higher layer parameter is a higher layer parameter for providing a window length of a configured time domain window,
in a case that the first higher layer parameter and the third higher layer parameter are provided, a hopping interval for the frequency hopping is determined based on the third higher layer parameter,
in a case that the first higher layer parameter and the second higher layer parameter are provided and the third higher layer parameter is not provided, the hopping interval is determined based on the second higher layer parameter, and
in a case that the first higher layer parameter is provided and the second higher layer parameter and the third higher layer parameter are not provided, no expectation is performed.

2. A base station apparatus comprising:
a transmitter configured to transmit a PDCCH to which DCI for scheduling a PUSCH is mapped;
a receiver configured to receive the PUSCH; and
a higher layer processing unit configured to manage a first higher layer parameter, a second higher layer parameter, and a third higher layer parameter, wherein
frequency hopping is applied for the PUSCH based at least on the DCI,
the first higher layer parameter is a higher layer parameter for providing whether DMRS bundling for the PUSCH is enabled,
the second higher layer parameter is a higher layer parameter for providing a window length of a configured time domain window,
in a case that the first higher layer parameter and the third higher layer parameter are provided, a hopping interval for the frequency hopping is determined based on the third higher layer parameter,
in a case that the first higher layer parameter and the second higher layer parameter are provided and the third higher layer parameter is not provided, the hopping interval is determined based on the second higher layer parameter, and
in a case that the first higher layer parameter is provided and the second higher layer parameter and the third higher layer parameter are not provided, no expectation is performed.

3. A communication method used by a terminal apparatus, the communication method comprising:
receiving a PDCCH to which DCI for scheduling a PUSCH is mapped;
transmitting the PUSCH; and
managing a first higher layer parameter, a second higher layer parameter, and a third higher layer parameter, wherein
frequency hopping is applied for the PUSCH based at least on the DCI,
the first higher layer parameter is a higher layer parameter for providing whether DMRS bundling for the PUSCH is enabled,
the second higher layer parameter is a higher layer parameter for providing a window length of a configured time domain window,
in a case that the first higher layer parameter and the third higher layer parameter are provided, a hopping interval for the frequency hopping is determined based on the third higher layer parameter,
in a case that the first higher layer parameter and the second higher layer parameter are provided and the third higher layer parameter is not provided, the hopping interval is determined based on the second higher layer parameter, and
in a case that the first higher layer parameter is provided and the second higher layer parameter and the third higher layer parameter are not provided, no expectation is performed.
